(19) United States
(12) Patent Application Publication
(10) Pub. No.: US 2024/0077309 A1
(43) Pub. Date: Mar. 7, 2024

(54) PHYSICAL ACTIVITY USER INTERFACES

(71) Applicant: Apple Inc., Cupertino, CA (US)

(72) Inventors: Nicholas D. FELTON, Sunnyvale, CA (US); James B. CARY, Mountain View, CA (US); Edward CHAO, Palo Alto, CA (US); Kevin W. CHEN, Cupertino, CA (US); Christopher P. FOSS, San Francisco, CA (US); Eamon F. GILRAVI, San Francisco, CA (US); Austen J. GREEN, Red Oak, TX (US); Bradley W. GRIFFIN, Aptos (US); Anders K. HAGLUNDS, Sunnyvale, CA (US); Lori HYLAN-CHO, Palo Alto, CA (US); Stephen P. JACKSON, San Francisco, CA (US); Matthew S. KOONCE, San Jose, CA (US); Paul T. NIXON, Los Altos, CA (US); Robert M. PEARSON, San Jose, CA (US)

(21) Appl. No.: 18/153,940

(22) Filed: Jan. 12, 2023

Related U.S. Application Data
(60) Provisional application No. 63/404,152, filed on Sep. 6, 2022.

(51) Int. Cl. G01C 5/06; B63C 11/02; G01F 23/18; G06F 3/01

(52) U.S. Cl. CPC G01C 5/06; B63C 11/02; G01F 23/18; G06F 3/016; B63C 2011/021

(57) ABSTRACT

The present disclosure generally relates to displaying information related to a physical activity. In some embodiments, methods and user interfaces for managing the display of information related to a physical activity are described.

### CROSS-REFERENCE TO RELATED APPLICATIONS

This application claims priority to U.S. Provisional Patent Application No. 63/404,152, entitled “PHYSICAL ACTIVITY USER INTERFACES,” filed on Sep. 6, 2022, the content of which is hereby incorporated by reference in its entirety.

### FIELD

The present disclosure relates generally to computer user interfaces, and more specifically to techniques for managing the display of information related to a physical activity.

### BACKGROUND

Users of electronic devices, such as smart watches and other computer systems, often perform physical activities while wearing the electronic device. An electronic device can provide the user with information regarding the physical activity both while the user is performing the physical activity and after the user has completed the physical activity.

### BRIEF SUMMARY

Some techniques for managing the display of information related to physical activity using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing the display of information related to physical activity. Such methods and interfaces optionally complement or replace other methods for managing the display of information related to a physical activity. Such methods and interfaces reduce the cognitive burden on a user and produce a more efficient human-machine interface. For battery-operated computing devices, such methods and interfaces conserve power and increase the time between battery charges.

In accordance with some embodiments, a method performed at a computer system that is in communication with a display generation component and one or more sensors is described. The method comprises: while the computer system is submerged, displaying, via the display generation component, a submersion user interface; while displaying the submersion user interface, detecting, via the one or more sensors, a first depth at which the computer system is submerged; and in response to detecting the first depth at which the computer system is submerged: in accordance with a determination that the first depth is less than a predetermined depth threshold, displaying, via the display generation component, a first set of metrics regarding the submersion of the computer system; and in accordance with a determination that the first depth is greater than the predetermined depth threshold, displaying, via the display generation component, a second set of metrics, that is different than the first set of metrics, regarding the submersion of the computer system.

In accordance with some embodiments a non-transitory computer readable storage is described. The non-transitory computer-readable storage medium storing one or more programs configured to be executed by one or more processors of a computer system, wherein the computer system is in communication with a display generation component and one or more sensors, the one or more programs including instructions for: while the computer system is submerged, displaying, via the display generation component, a submersion user interface; while displaying the submersion user interface, detecting, via the one or more sensors, a first depth at which the computer system is submerged; and in response to detecting the first depth at which the computer system is submerged: in accordance with a determination that the first depth is less than a predetermined depth threshold, displaying, via the display generation component, a first set of metrics regarding the submersion of the computer system; and in accordance with a determination that the first depth is greater than the predetermined depth threshold, displaying, via the display generation component, a second set of metrics, that is different than the first set of metrics, regarding the submersion of the computer system.

In accordance with some embodiments a transitory computer readable storage is described. The transitory computer-readable storage medium storing one or more programs configured to be executed by one or more processors of a computer system, wherein the computer system is in communication with a display generation component and one or more sensors, the one or more programs including instructions for: while the computer system is submerged, displaying, via the display generation component, a submersion user interface; while displaying the submersion user interface, detecting, via the one or more sensors, a first depth at which the computer system is submerged; and in response to detecting the first depth at which the computer system is submerged: in accordance with a determination that the first depth is less than a predetermined depth threshold, displaying, via the display generation component, a first set of metrics regarding the submersion of the computer system; and in accordance with a determination that the first depth is greater than the predetermined depth threshold, displaying, via the display generation component, a second set of metrics, that is different than the first set of metrics, regarding the submersion of the computer system.

In accordance with some embodiments, a computer system is described. The computer system comprises one or more processors, wherein the computer system is in communication with a display generation component and one or more sensors; and memory storing one or more programs configured to be executed by the one or more processors, the one or more programs including instructions for: while the computer system is submerged, displaying, via the display generation component, a submersion user interface; while displaying the submersion user interface, detecting, via the one or more sensors, a first depth at which the computer system is submerged; and in response to detecting the first depth at which the computer system is submerged: in accordance with a determination that the first depth is less than a predetermined depth threshold, displaying, via the display generation component, a first set of metrics regarding the submersion of the computer system; and in accordance with a determination that the first depth is greater than the predetermined depth threshold, displaying, via the display generation component, a second set of metrics, that is different than the first set of metrics, regarding the submersion of the computer system.

In accordance with some embodiments, a computer system is described. The computer system, comprises: one or more processors, wherein the computer system is in communication with a display generation component and one or more sensors; memory storing one or more programs configured to be executed by the one or more processors; means for while the computer system is submerged, displaying, via the display generation component, a submersion user interface; means for while displaying the submersion user interface, detecting, via the one or more sensors, a first depth at which the computer system is submerged; and means, responsive to detecting the first depth at which the computer system is submerged, for: in accordance with a determination that the first depth is less than a predetermined depth threshold, displaying, via the display generation component, a first set of metrics regarding the submersion of the computer system; and in accordance with a determination that the first depth is greater than the predetermined depth threshold, displaying, via the display generation component, a second set of metrics, that is different than the first set of metrics, regarding the submersion of the computer system.

In accordance with some embodiments, a computer program product is described. The computer program product comprising one or more programs configured to be executed by one or more processors of a computer system that is in communication with a display generation component and one or more sensors, the one or more programs including instructions for: While the computer system is submerged, displaying, via the display generation component, a submersion user interface; While displaying the submersion user interface, detecting, via the one or more sensors, a first depth at which the computer system is submerged; and in response to detecting the first depth at Which the computer system is submerged: in accordance with a determination that the first depth is less than a predetermined depth threshold, displaying, via the display generation component, a first set of metrics regarding the submersion of the computer system; and in accordance with a determination that the first depth is greater than the predetermined depth threshold, displaying, via the display generation component, a second set of metrics, that is different than the first set of metrics, regarding the submersion of the computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing the display of information related to a physical activity, thereby increasing the effectiveness, efficiency, and user satisfaction with such devices. Such methods and interfaces may complement or replace other methods for managing the display of information related to a physical activity.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6M illustrate schematics and exemplary user interfaces for managing the display of information related to a physical activity, in accordance with some embodiments.

FIG. 7 is a flow diagram illustrating a method for managing the display of information related to physical activity, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing the display of information related to a physical activity. For example, there is a need for electronic devices that allow a user the ability to quickly and easily view metrics that are associated with a physical activity that the user is performing. Such techniques can reduce the cognitive burden on a user who accesses information related to a physical activity, thereby enhancing productivity. Further, such techniques can reduce processor and battery power otherwise wasted on redundant user inputs.

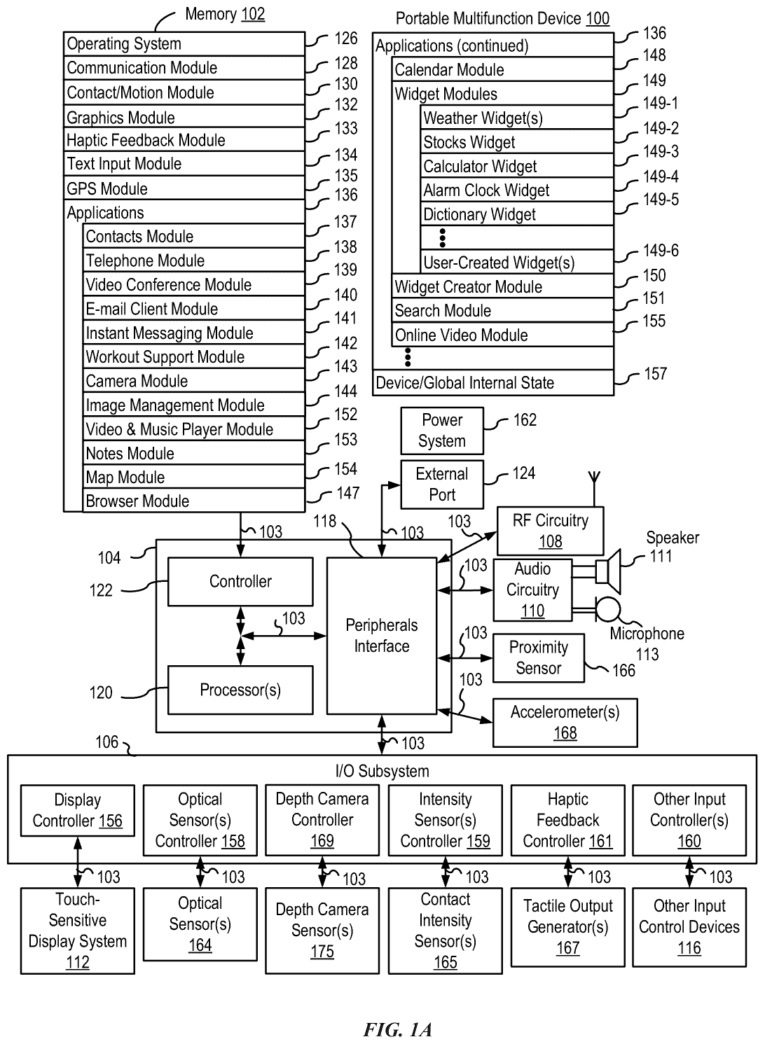

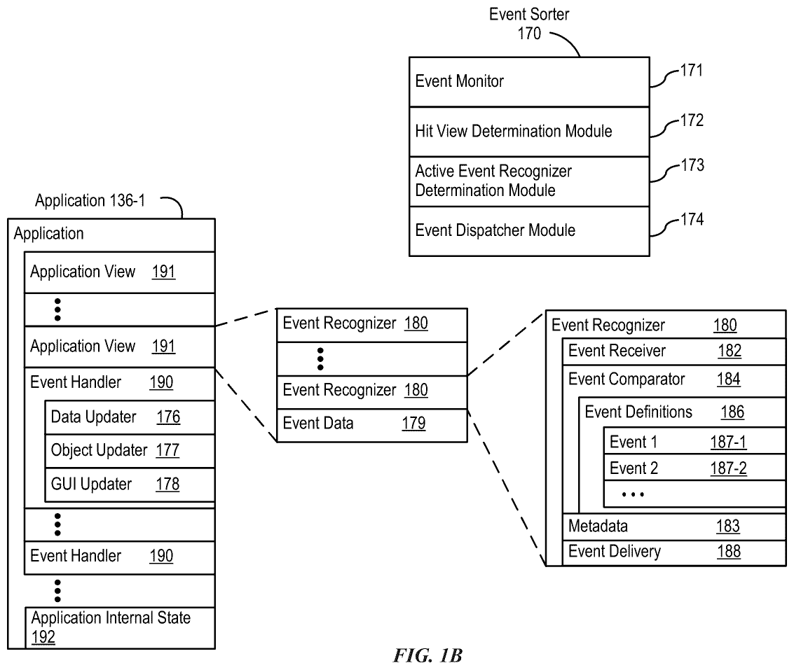

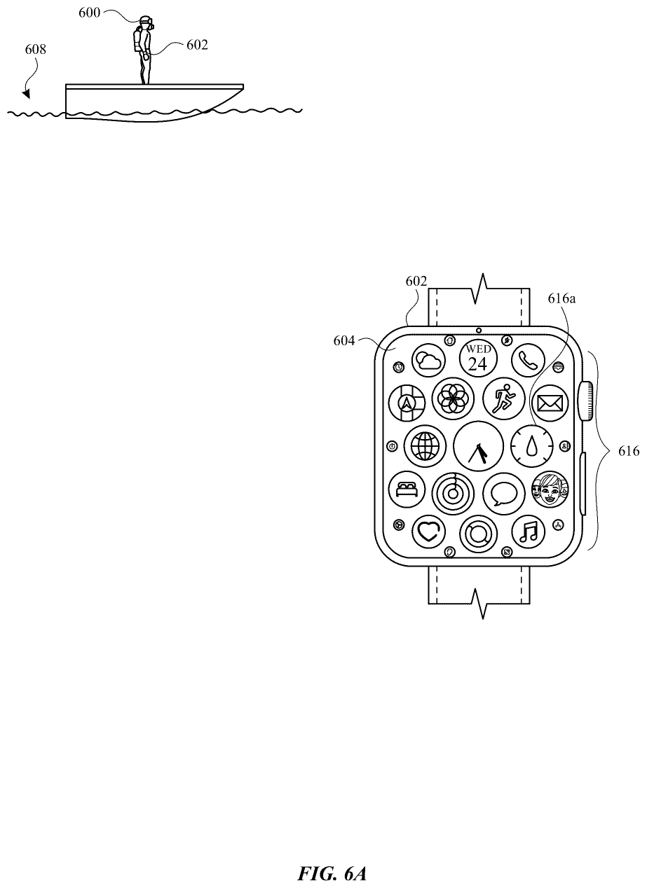

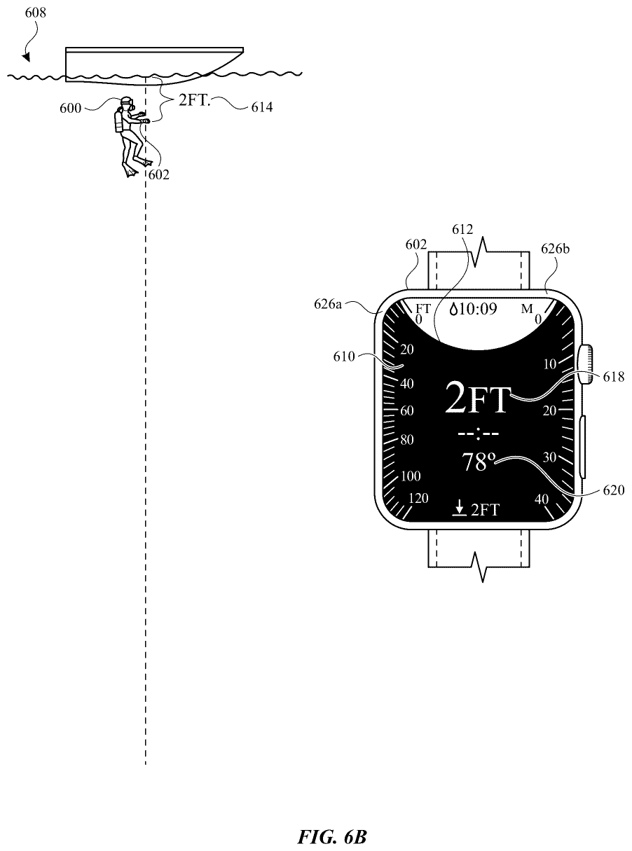

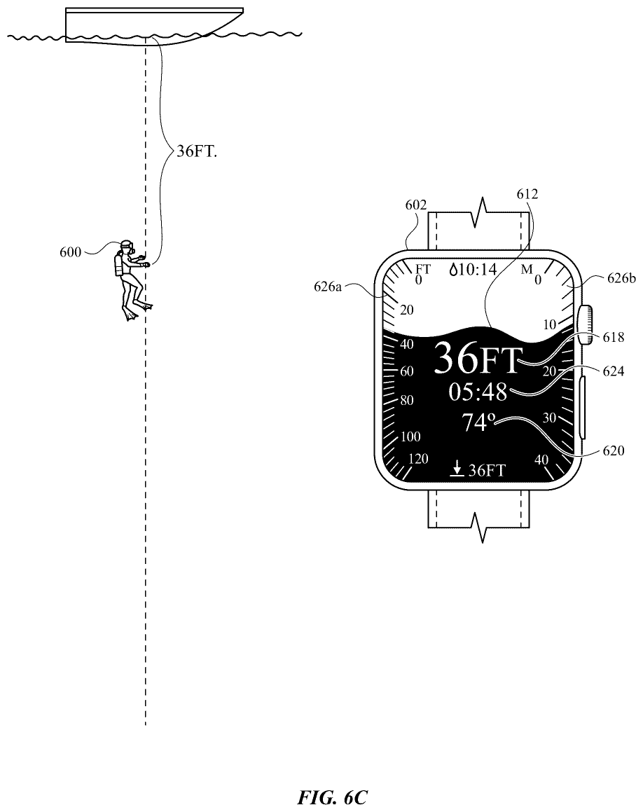

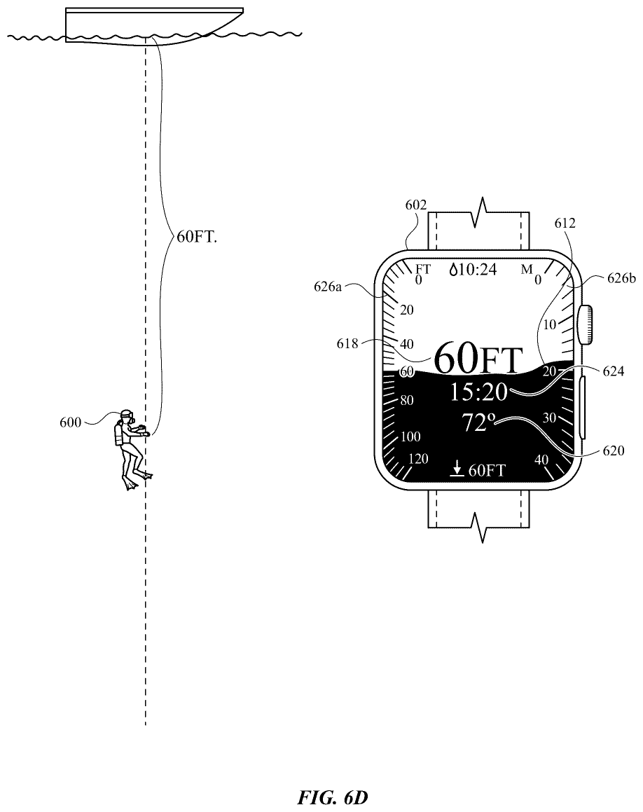

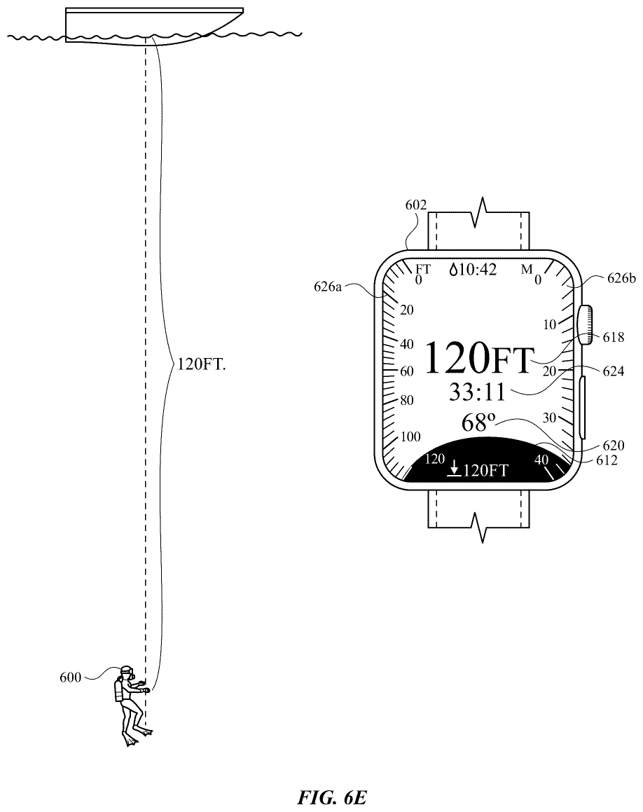

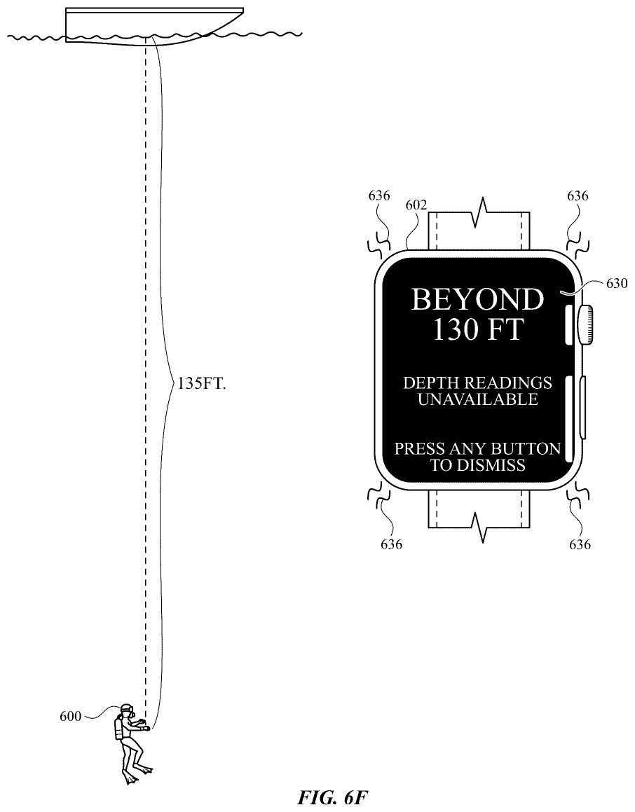

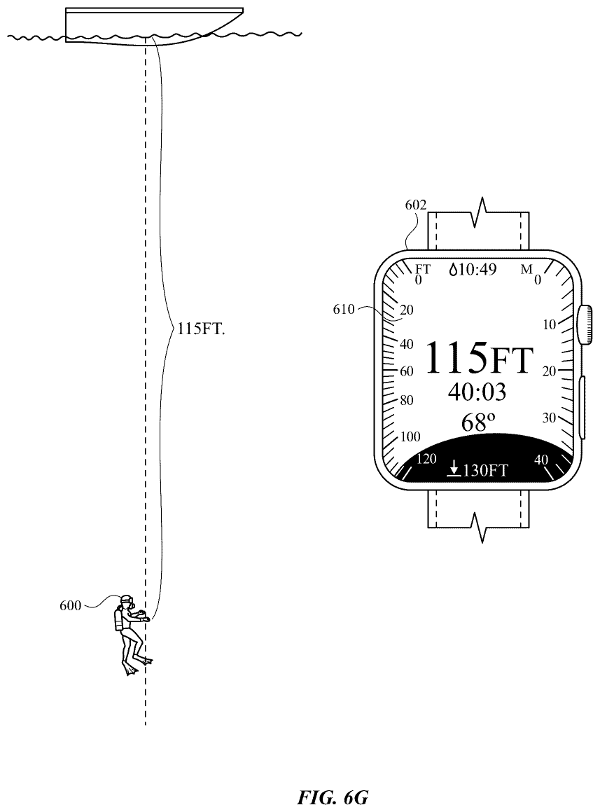

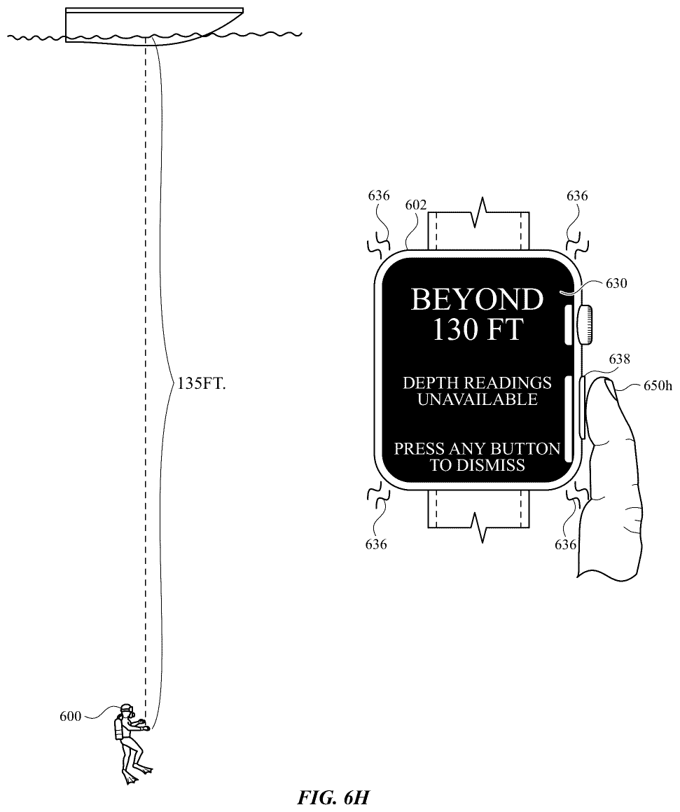

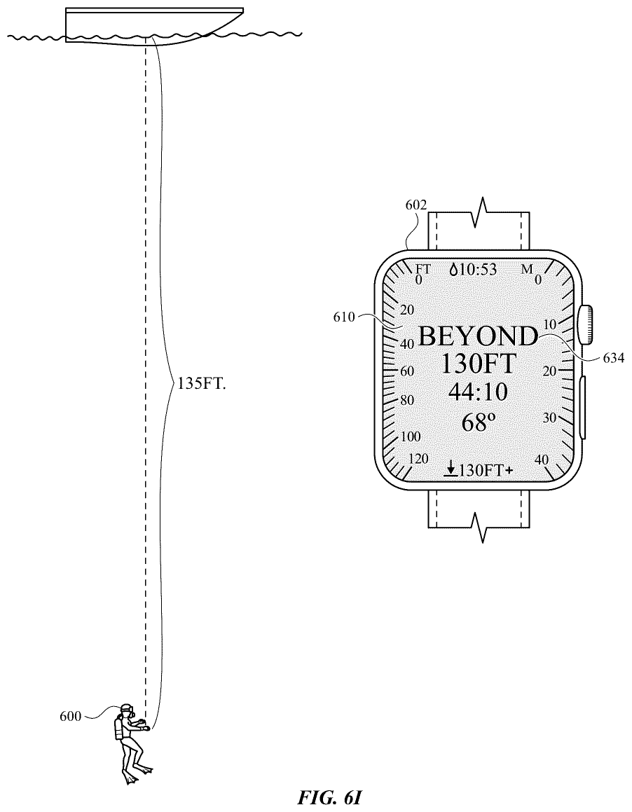

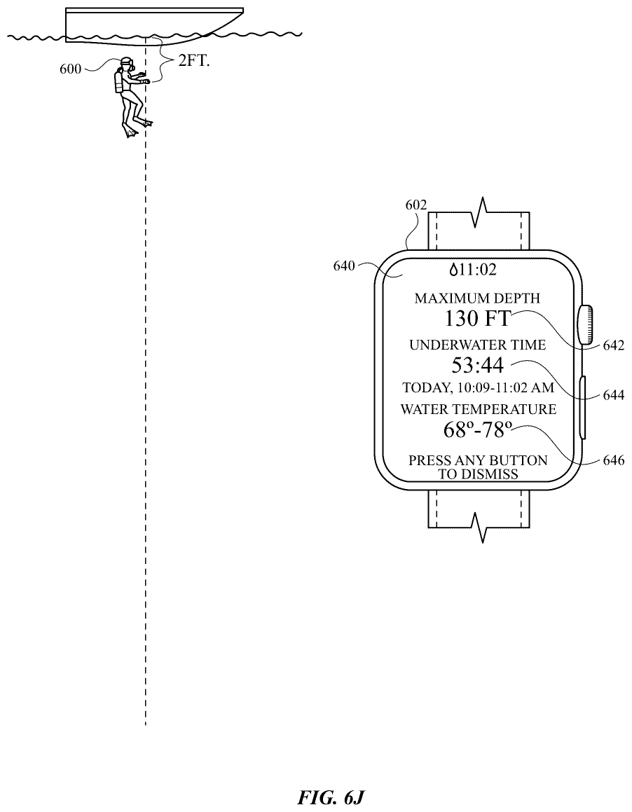

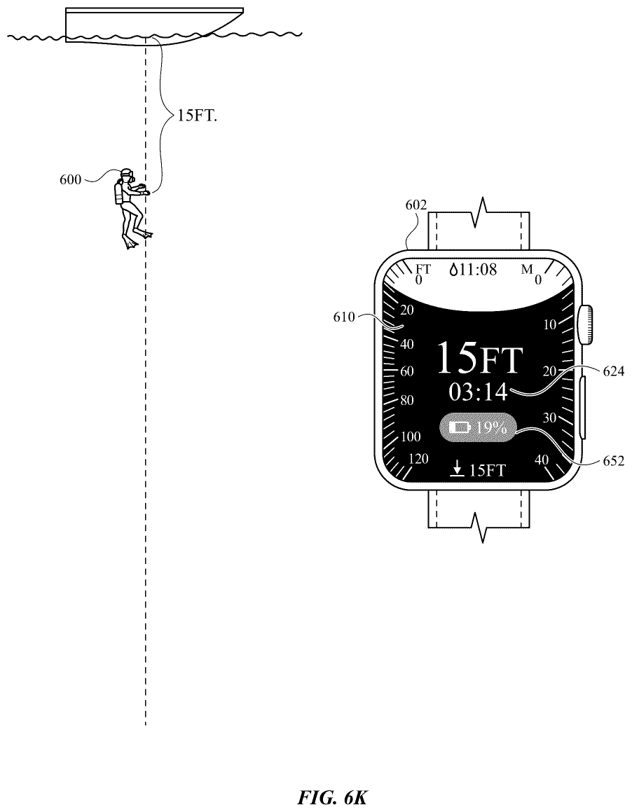

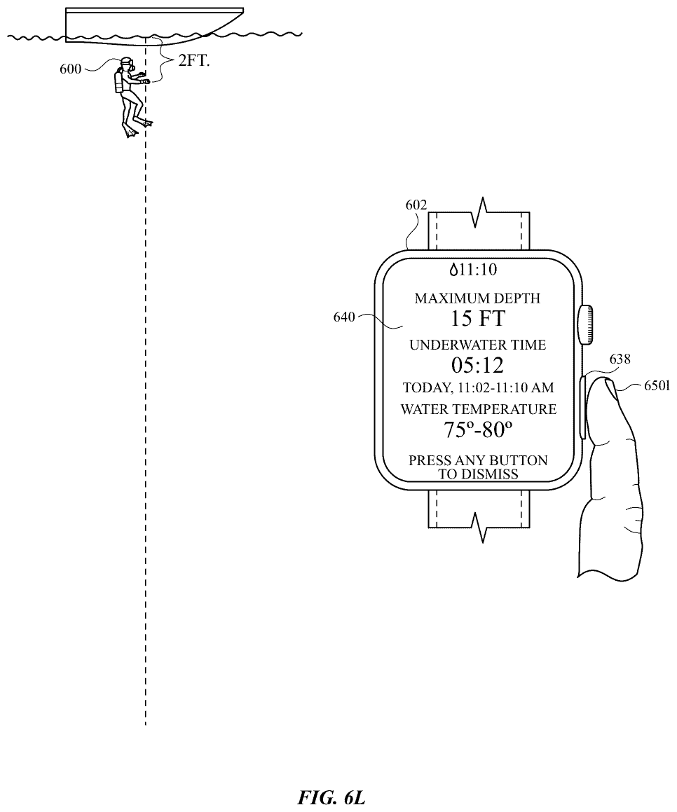

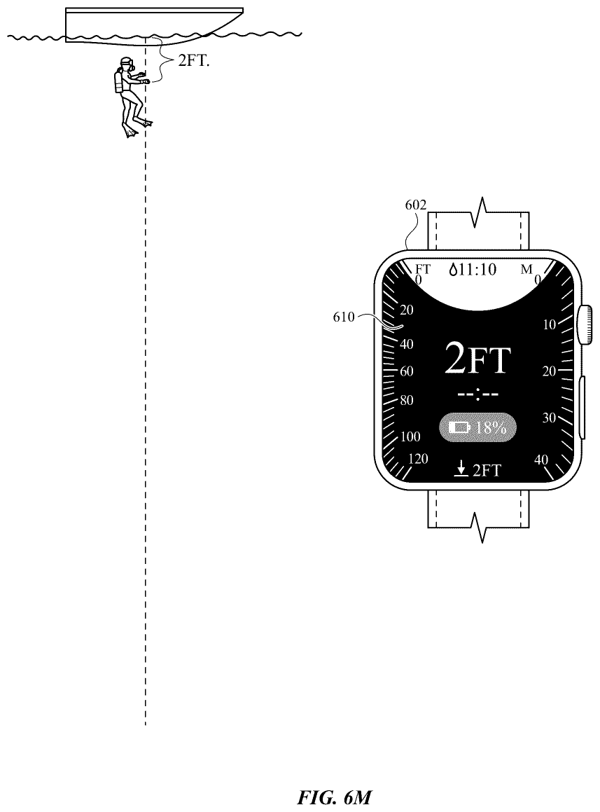

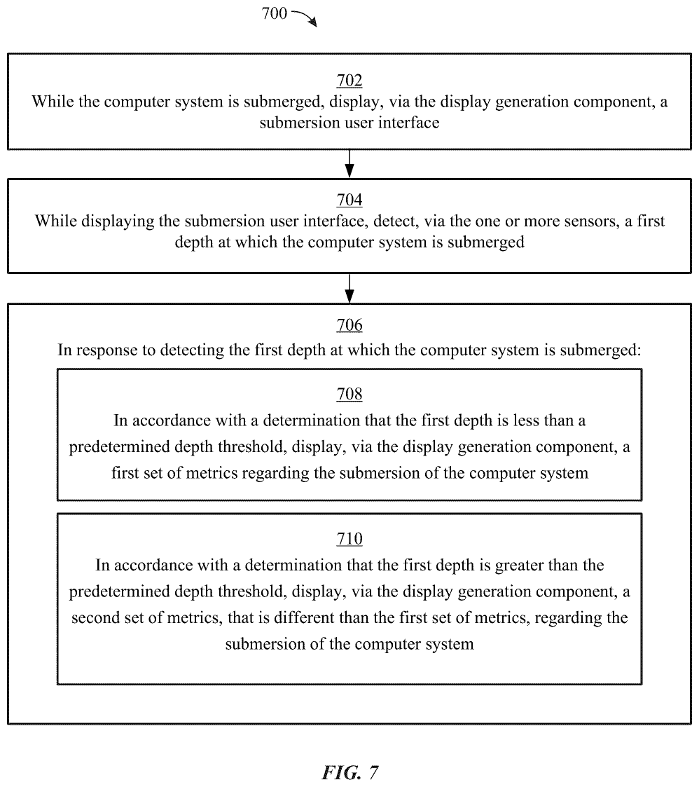

Below, FIGS. 1A-1B, 2, 3, 4A-4B, and 5A-5B provide a description of exemplary devices for performing the techniques for managing event notifications. FIGS. 6A-6M illustrate exemplary user interfaces for managing the display of information related to a physical activity. FIG. 7 is a flow diagram illustrating methods of managing the display of information related to a physical activity in accordance with some embodiments. The user interfaces in FIGS. 6A-6M are used to illustrate the processes described below, including the process in FIG. 7.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

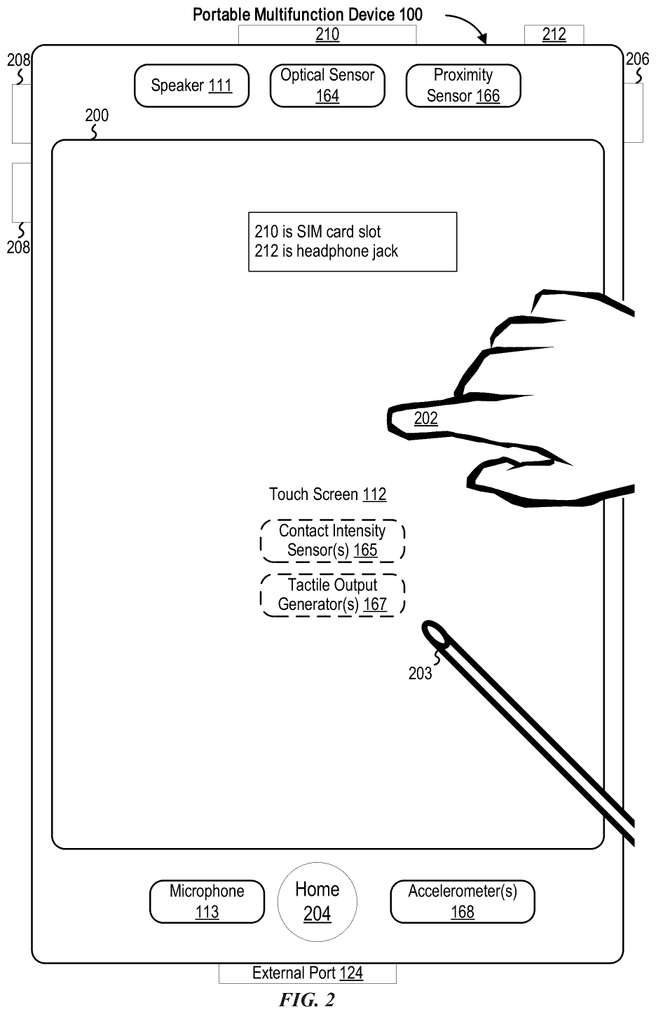

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

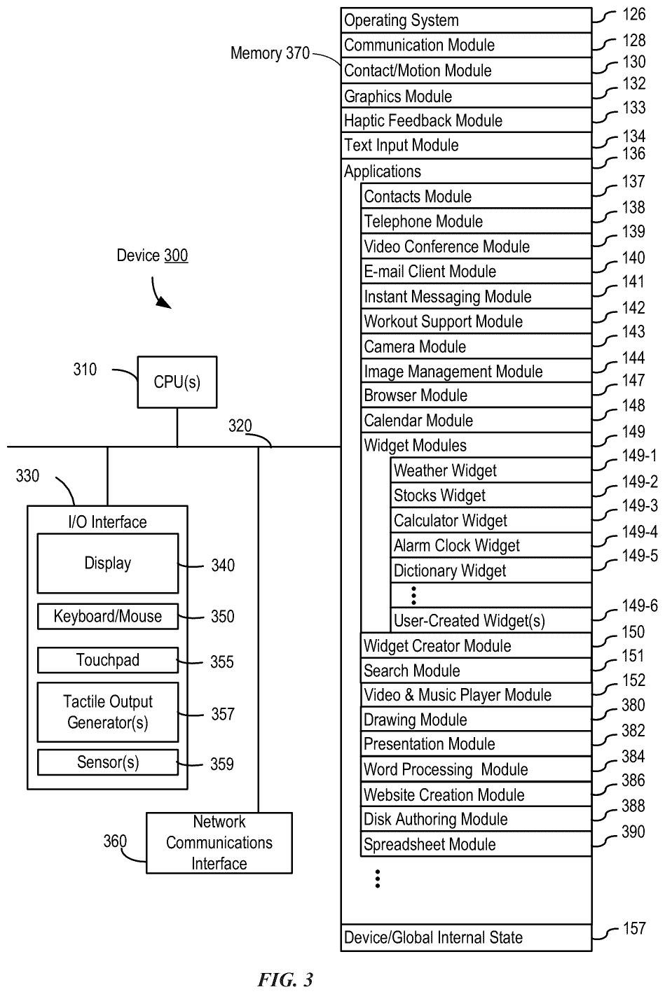

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

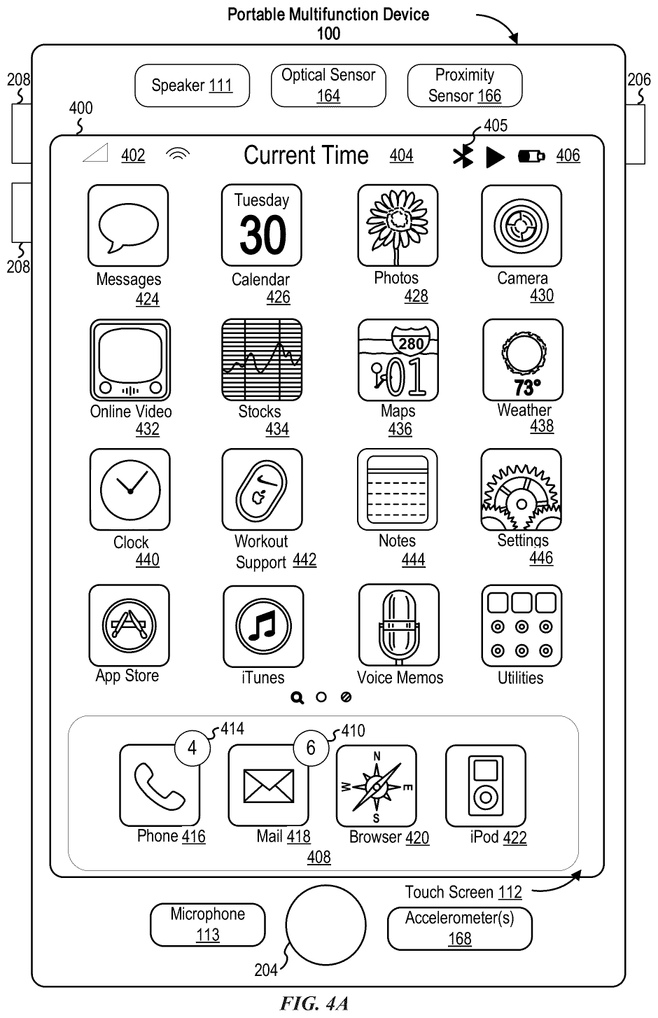

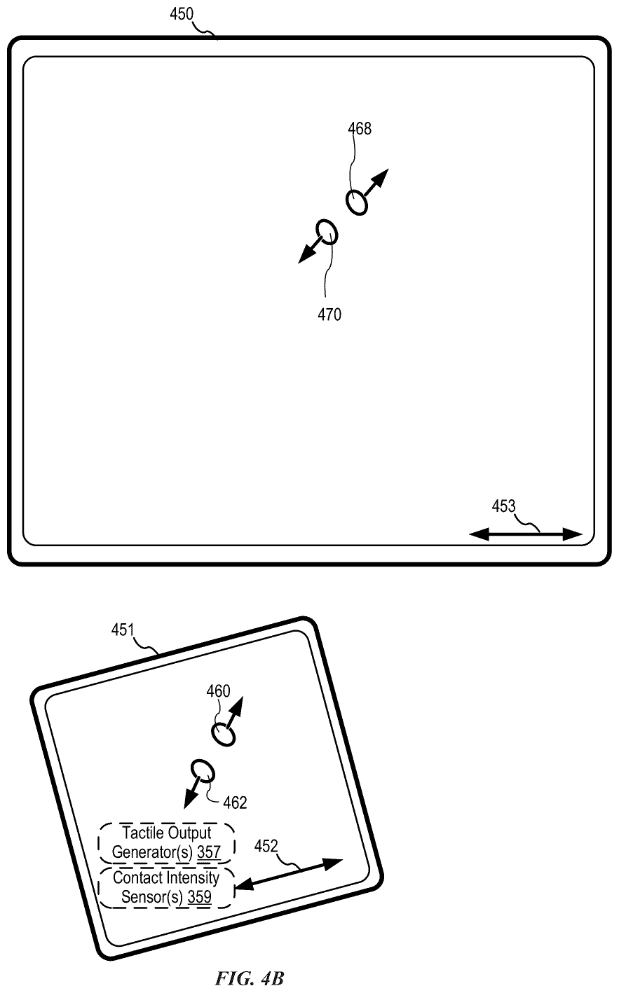

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

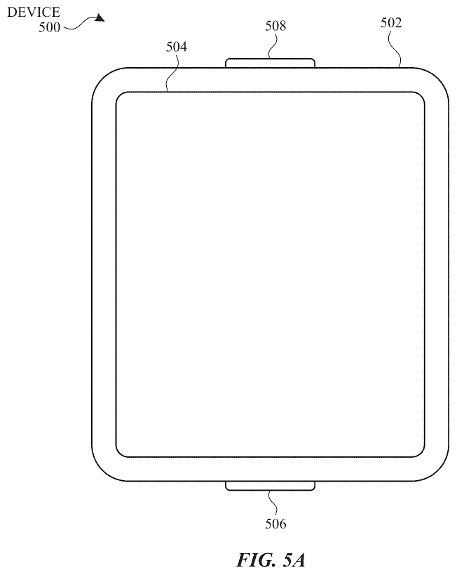

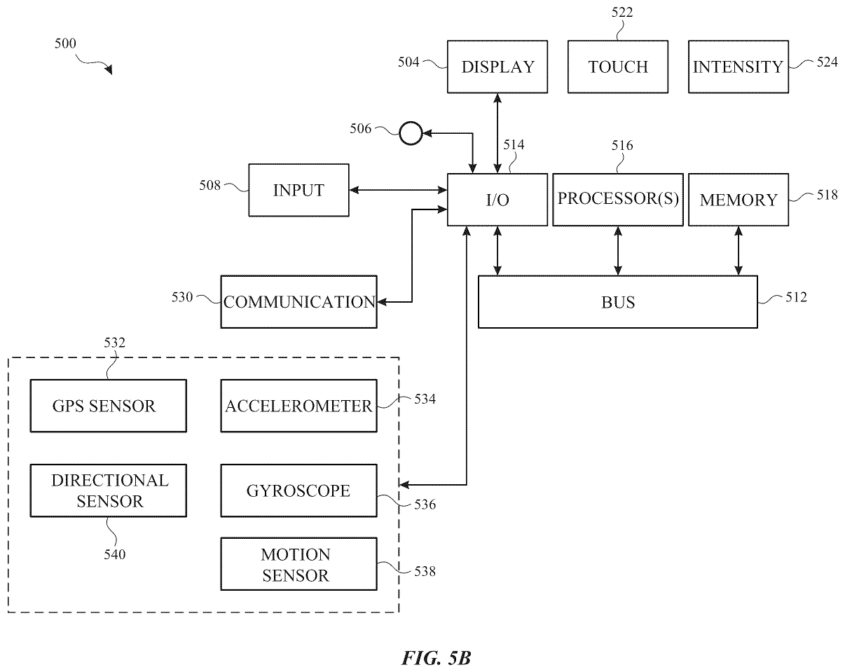

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6M illustrate exemplary user interfaces for managing the display of information related to a physical activity, in accordance with some embodiments. The user interfaces in these figures are used to illustrate the processes described below, including the processes in FIG. 7.

The left half of FIG. 6A includes diagram 608. Diagram 608 depicts the relationship of user 600 relative to a body of water (e.g., an ocean, pond, diving pool, or lake). As illustrated in FIG. 6A by diagram 608, user 600 is positioned within a boat on the surface of the body of water (e.g., user 600 is not submerged within the body of water). Further, as illustrated in FIG. 6A, user 600 is wearing computer system 602 on the wrist of user 600. At FIG. 6A, user 600 and computer system 602 are not submerged in the body of water.

The right half of FIG. 6A depicts a detailed depiction of computer system 602. At FIG. 6A, computer system 602 displays springboard user interface 604. As illustrated in FIG. 6A, springboard user interface 604 includes plurality of application user interface objects 616. Each user interface object in plurality of application user interface objects 616 corresponds to a respective application that is installed on computer system 602. Computer system 602 launches a respective application in response to detecting a selection of a respective application user interface object in plurality of application user interface objects 616. Plurality of application user interface objects 616 includes diving application user interface object 616a. Diving application user interface object 616a corresponds to a diving application that is installed on computer system 602. While computer system 602 is depicted as a smart watch, it should be recognized that this is merely an example and techniques described herein can work with other types of computer systems, such as a smart phone and/or a diving computer. Throughout the discussion of FIGS. 6A-6M, various references are made with respect to determinations being made regarding the depth of computer system 602. In some embodiments, computer system 602 makes the determination regarding the depth of computer system 602 using one or more depth detection techniques (e.g., using one or more sensors that are integrated into computer system 602).

At FIG. 6B the positioning of user 600 transitions from being outside of the body of water to being submerged within the body of water. At FIG. 6B, a determination is made that computer system 602 is submerged in the body of water (e.g., the determination is made via one or more sensors that are in communication (e.g., wired communication and/or wireless communication) with computer system 602). Because a determination is made that computer system 602 is submerged within the body of water, computer system 602 displays submersion user interface 610. That is, computer system 602 automatically (e.g., without an intervening input) displays submersion user interface 610 when a detection is made that computer system 602 is submerged in the body of water. Submersion user interface 610 corresponds to the diving application that is installed on computer system 602. In some embodiments, computer system 602 displays submersion user interface 610 in response to detecting an input (e.g., tap input, swipe input, and/or activation of a hardware control that is integrated to computer system 602) that corresponds to selection of diving application user interface object 616a (e.g., as shown in FIG. 6A). In some embodiments, computer system 602 automatically (e.g., without intervening user input) ceases the display of submersion user interface 610 in accordance with a determination that computer system 602 is no longer submerged in the body of water.

As illustrated in FIG. 6B, submersion user interface 610 includes depth metric 618 and temperature metric 620. Depth metric 618 indicates the current depth of computer system 602 from the surface of the body of water as measured in feet. Temperature metric 620 indicates the current temperature of the body of water as measured in Fahrenheit degrees. In some embodiments, temperature metric indicates the current temperature of the body of water in Celsius. In some embodiments, depth metric 618 indicates the depth of computer system 602 in meters. In some embodiments, temperature metric 620 indicates the current temperature of the body of water in both Fahrenheit and Celsius. In some embodiments, depth metric 618 indicates the current depth of computer system 602 in both feet and meters. In some embodiments, computer system 602 displays temperature metric 620 above depth metric 618.

Additionally, as illustrated in FIG. 6B, submersion user interface 610 includes depth animation 612, depth scale 626a, and depth scale 626b. Depth scale 626a includes a number of lines that each represent a depth distance measured in feet. The distances represented by depth scale 626a range from 0 feet to 120 feet. Similarly, depth scale 626b includes a number of lines that each represent a respective depth distance measured in meters. The distances represented by depth scale 626b range from 0 meters to 40 meters.

Computer system 602 displays the leftmost portion of depth animation 612 at a point on depth scale 626a that corresponds to the current depth of computer system 602 and computer system 602 displays the rightmost portion of depth animation 612 at a point on depth scale 626b that corresponds to the current depth of computer system 602. As discussed in greater detail below, computer system 602 moves the display of depth animation 612 on the display of computer system 602 based on the detected depth of computer system 602. In some embodiments, computer system 602 displays depth animation 612 such that depth animation 612 mimics the dynamic properties of a water meniscus (e.g., the display of depth animation 612 depends on the rotational orientation of computer system 602).

At FIG. 6B, because a determination is made that computer system 602 is submerged in the body of water, computer system 602 enters a water lock state. Computer system 602 has reduced functionally while computer system 602 is in the water lock state. That is, when computer system 602 is in a normal operating state, computer system 602 performs one or more respective operations in response to detecting a respective user input (e.g., a tactile input on the display of computer system 602). However, computer system 602 forgoes performing one or more respective operations in response to detecting a respective user input (e.g., tactile inputs on the display of computer system 602) while computer system 602 is in the water lock state (e.g., computer system 602 rejects tactile inputs while computer system 602 is in the water lock state).

At FIG. 6C, user 600 descends to a deeper depth within the body of water. At FIG. 6C, a determination is made that computer system 602 is 36 feet beneath the surface of the body of water (e.g., as indicated by depth metric 618). At FIG. 6C, because a determination is made that the depth of computer system 602 is 36 feet beneath the surface of the body of water, computer system 602 updates the display of depth animation 612. That is, at FIG. 6C, computer system 602 moves the leftmost portion of depth animation 612 to a position on depth scale 626a that corresponds to 36 feet. Further, at FIG. 6C, computer system 602 moves the rightmost portion of depth animation 612 to a position on depth scale 626b that corresponds to 36 feet (e.g., 10.9 meters). The display of both depth metric 618 and temperature metric 620 is dynamic. Accordingly, at FIG. 6C, because it is determined that the depth of computer system 602 is at 36 feet, computer system 602 updates the display of depth metric 618 to indicate that the current depth of computer system 602 is 36 feet. Further, at FIG. 6C, a determination is made that the temperature of the body of water is 74 degrees. Because a determination is made that the temperature of the body of water is 74 degrees, computer system 602 updates the display of temperature metric 620 to indicate the detected temperature of the body of water.

At FIG. 6C, a determination is made that the depth of computer system 602 is greater than a predetermined depth threshold (e.g., 4 feet, 6 feet, 8 feet, or 10 feet). Because a determination is made that the depth of computer system 602 is greater than the predetermined depth threshold, computer system 602 initiates the tracking and recording of metrics for a first diving session of user 600. Computer system 602 initiates a dive timer as part of tracking and recording metrics for the first dive session. The dive timer records the amount of time that computer system 602 is submerged at a depth that is greater than the predetermined depth threshold. Further, because a determination is made that the depth of computer system 602 is greater than the predetermined depth threshold, computer system 602 displays time metric 624. Time metric 624 indicates the amount of time (e.g., in minutes and seconds) that computer system 602 has been submerged at a depth that is greater than the predetermined depth threshold. In some embodiments, time metric 624 indicates the amount of time computer system 602 has been submerged at a depth that is greater than the predetermined depth threshold in seconds (e.g., and not minutes and seconds). In some embodiments, time metric 624 indicates the amount of time computer system 602 has been submerged within the body of water. In some embodiments, computer system 602 displays time metric 624 in accordance with a determination that computer system 602 is submerged in the body of water.

As illustrated in FIG. 6C, computer system 602 displays depth animation 612 behind depth metric 618, time metric 624, and temperature metric 620. Computer system 602 displays depth metric 618, time metric 624, and temperature metric 620 with a white color that contrasts with the black color of depth animation 612 while computer system 602 displays depth animation 612 behind depth metric 618, time metric 624, and temperature metric 620. In some embodiments, computer system 602 displays depth metric 618, time metric 624, and temperature metric 620 as a non-white color (e.g., red, blue, green, and/or yellow) that contrasts with the display of depth animation 612 while computer system 602 displays depth animation 612 behind depth metric 618, time metric 624, and temperature metric 620.

At FIG. 6C, because a determination is made that the depth of computer system 602 is greater than the predetermined depth threshold, computer system 602 enters a dive lock state (e.g., and exits the water lock state). Computer system 602 suppresses alerts (e.g., visual alerts, audio alerts, vibrational alerts) that computer system 602 would output if computer system 602 were in a normal operating state. Further, while computer system 602 is in the dive lock state, computer system 602 illuminates the display of computer system (e.g., via one or more light sources that computer system 602 is in communication with). Computer system 602 exits the dive lock state (e.g., and transitions to a normal operating state or the water lock state described above) in response to detecting a user input that corresponds to an activation (e.g., a) of a hardware button (e.g., a rotatable crown button and/or side button) (e.g., the hardware button is pressed down) that is integrated into computer system 602. While computer system 602 is in the dive lock state, computer system 602 performs a respective operation (e.g., launches an application, displays an animation, and/or displays a respective user interface) in response to detecting that a hardware button of computer system 602 is depressed (e.g., the hardware button is pressed down). In contrast, while computer system 602 is not in the dive lock state (e.g., computer system 602 is in a normal operating state or the water lock state) computer system 602 performs a respective operation in response to detecting that a hardware button is depressed and then released (e.g., the hardware button returns to its initial position). Additionally, while computer system 602 is in the dive lock state, computer system 602 does not perform any operation in response to detecting a long press (e.g., press and hold) of a hardware button and/or in response to detecting a series of one or more inputs (e.g., double clicking a hardware button).

At FIG. 6D, user 600 descends to a deeper depth within the body of water. At FIG. 6D, a determination is made that computer system 602 is 60 feet beneath the surface of the body of water (e.g., as indicated by depth metric 618). At FIG. 6D, because a determination is made that computer system 602 is 60 feet beneath the surface of the body of water, computer system 602 updates the display of depth animation 612. That is, at FIG. 6D, computer system 602 moves the leftmost portion of depth animation 612 to a position on depth scale 626a that corresponds to 60 feet. Further, at FIG. 6D, computer system 602 moves the rightmost portion of depth animation 612 to a position on depth scale 626b that corresponds to 60 feet (e.g., 18.2 meters).

At FIG. 6D, computer system 602 does not display depth animation 612 behind depth metric 618 (e.g., because computer system 602 moves the display of depth animation 612 down on the display of computer system 602). Computer system 602 changes the display color of depth metric 618 from white (e.g., as shown in FIG. 6C) to black because depth animation 612 is not displayed behind depth metric 618. At FIG. 6D, computer system 602 maintains the display of time metric 624 and temperature metric 620 with a white color because computer system 602 displays depth animation 612 behind both time metric 624 and temperature metric 620. In some embodiments, computer system 602 displays depth metric 618 as a non-black color (e.g., yellow, red, green, blue, and/or orange) when computer system 602 does not display depth animation 612 behind depth metric 618.

At FIG. 6E, user 600 descends to a deeper depth within the body of water. At FIG. 6E, a determination is made that computer system 602 is 120 feet beneath the surface of the body of water (e.g., as indicated by depth metric 618). At FIG. 6E, because a determination is made that computer system 602 is 120 feet beneath the surface of the body of water, computer system 602 updates the display of depth animation 612. That is, at FIG. 6E, computer system 602 moves the leftmost portion of depth animation 612 to a position on depth scale 626a that corresponds to 120 feet. Further, at FIG. 6E, computer system 602 moves the rightmost portion of depth animation 612 to a position on depth scale 626b that corresponds to 120 feet (36.5 meters).

At FIG. 6E, computer system 602 does not display depth animation 612 behind time metric 624, depth metric 618, and temperature metric 620 (e.g., because computer system 602 moves the display of depth animation 612 down on the display of computer system 602). Because computer system 602 does not display depth animation 612 behind time metric 624, depth metric 618, and temperature metric 620, computer system 602 displays each of time metric 624, depth metric, and temperature metric 620 with a black color (e.g., as opposed to a white color as shown in FIG. 6C). Similar to depth metric 618, computer system 602 displays time metric 624 and temperature metric 620 with a color that contrasts with depth animation 612 while depth animation 612 is displayed behind time metric 624 and temperature metric 620. Computer system 602 changes the color of time metric 624 and temperature metric 620 when depth animation 612 is not displayed behind time metric 624 and temperature metric 620. In some embodiments, computer system 602 displays time metric 624 with a black color and temperature metric 620 with a white color when computer system 602 displays depth animation 612 behind temperature metric 620 but not time metric 624.

At FIG. 6F, user 600 descends to a deeper depth within the body of water. At FIG. 6F, a determination is made that the depth of computer system 602 is greater than a maximum depth threshold (e.g., 110, 120, 125, 130, 140, or 150 feet). Because a determination is made that the depth of computer system 602 is greater than the maximum depth threshold, computer system 602 automatically (e.g., without intervening user input) displays depth warning user interface 630. Computer system 602 replaces the display of submersion user interface 610 with the display of depth warning user interface 630. Depth warning user interface 630 provides an indication that the depth of computer system 602 is greater than the maximum depth threshold. In some embodiments, computer system 602 pulsates (e.g., repeatedly flashes) the display of depth warning user interface 630. In some embodiments, computer system 602 activates one or more light sources that are in communication with computer system 602 while depth warning user interface 630 is displayed.

Further, at FIG. 6F, because a determination is made that computer system 602 is at a depth that is greater than the maximum depth threshold, computer system 602 outputs continuous haptic feedback 636. Computer system 602 outputs continuous haptic feedback 636 while the depth of computer system 602 is detected to be greater than the maximum depth threshold. In some embodiments, while the depth of computer system 602 is greater than the maximum depth threshold, the intensity of continuous haptic feedback 636 is directly proportional to the depth of computer system 602 (e.g., the intensity of continuous haptic feedback 636 increases as the depth of computer system 602 increases or decreases as the depth of computer system 602 decreases). In some embodiments, computer system 602 outputs a discrete haptic feedback (e.g., a single vibrational output) in response to a determination that the depth of computer system 602 is greater than the maximum depth threshold.

At FIG. 6G, user 600 ascends within the body of water. At FIG. 6G, a determination is made that the depth of computer system 602 transitions from being greater than the maximum depth threshold to less than the maximum depth threshold. Because a determination is made that the depth of computer system 602 transitions from being greater than the maximum depth threshold to less than the maximum depth threshold, computer system 602 ceases the display of depth warning user interface 630 and redisplays submersion user interface 610. Computer system 602 automatically (e.g., without intervening user input) ceases the display of depth warning user interface 630 and redisplays submersion user interface 610 upon computer system 602 being repositioned above the maximum depth threshold. Further, at FIG. 6G, because a determination is made that the depth of computer system 602 transitions from being greater than the maximum depth threshold to less than the maximum depth threshold, computer system 602 ceases to output continuous haptic feedback 636.

At FIG. 6H, user 600 descends to a deeper depth within the body of water. At FIG. 6H, a determination is made that the depth of computer system 602 is greater than the maximum depth threshold. Because a determination is made that the depth of computer system 602 is greater than the maximum depth threshold, computer system 602 redisplays depth warning user interface 630 and outputs continuous haptic feedback 636 (e.g., as described above at FIG. 6F). At FIG. 6H, computer system 602 detects input 650h that corresponds to an activation of side button 638.

At FIG. 6I, in response to detecting input 650h, computer system 602 ceases the display of depth warning user interface 630 and redisplays submersion user interface 610. At FIG. 6I, computer system 602 is maintained at a depth that is greater than the maximum depth threshold (e.g., the depth of computer system 602 does not change between FIGS. 6H and 6I). Computer system 602 ceases the display of depth warning user interface 630 in response to detecting input 650h even though the depth of computer system 602 is greater than the maximum depth threshold.

Submersion user interface 610 does not include depth metric 618 when computer system 602 displays submersion user interface 610 while the depth of computer system 602 is greater than the maximum depth threshold. Rather, as illustrated in FIG. 6I, when the depth of computer system 602 is greater than the maximum depth threshold, submersion user interface 610 includes depth warning 634. Further, while the depth of computer system 602 is greater than the maximum depth threshold, submersion user interface 610 does not include depth animation 612. Rather, while the depth of computer system 602 is greater than the maximum depth threshold, computer system 602 displays the background of submersion user interface 610 as a solid color (e.g., yellow, black, red, and/or orange). In some embodiments, computer system 602 continues to track the depth of computer system 602 while the depth of computer system 602 is greater than the maximum depth threshold. In some embodiments, computer system 602 displays depth metric 618 while the depth of computer system 602 is greater than the maximum depth threshold.

At FIG. 6J, user 600 ascends within the body of water. At FIG. 6J, a determination is made that the depth of computer system 602 transitions from being greater than the predetermined depth threshold to less than the predetermined depth threshold. At FIG. 6J, because a determination is made that the depth of computer system 602 transitions from being greater than the predetermined depth threshold to less than the predetermined depth threshold, computer system 602 stops tracking metrics for the first diving session. Accordingly, the descent of computer system 602 from across the predetermined depth threshold represents the start of the first diving session and the ascent of computer system 602 across the predetermined depth threshold represents the end of the first diving session. In some embodiments, because a determination is made that the depth of computer system 602 transitions from being greater than the predetermined depth threshold to less than the predetermined depth threshold, computer system 602 transitions from the dive lock state to the water lock state.

As illustrated in FIG. 6J, because a determination is made that the depth of computer system 602 transitions from being greater than the predetermined depth threshold to less than the predetermined depth threshold, computer system 602 displays summary user interface 640. Summary user interface 640 includes a summary of the various metrics that computer system 602 tracked and recorded during the first diving session. Summary user interface 640 includes maximum depth metric 642, dive time metric 644, and water temperature range metric 646. Maximum depth metric 642 indicates the deepest detected depth of computer system 602 during the first diving session. Dive time metric 644 indicates the amount of time that elapsed during the first diving session. Water temperature range metric 646 indicates the range of the detected temperature of the body of water during the first diving session. In some embodiments, summary user interface 640 includes additional information that computer system 602 tracked during the first diving session (e.g., geographical location of the first diving session, amount of oxygen consumed by user 600 during the first diving session, range of the heart rate of user 600 during the first diving session, and/or range of water pressure during first diving session). In some embodiments, computer system 602 ceases the display of summary user interface 640 in accordance with a determination that computer system 602 is no longer submerged in the body of water. In some embodiments, in accordance with a determination that computer system 602 is no longer submerged in the body of water, computer system 602 transmits instructions to an external device (e.g., a smart phone that is owned by user 600) that causes the external device to display summary user interface 640. In some embodiments, in accordance with a determination that the depth of computer system 602 transitions from being greater than the predetermined depth threshold to less than the predetermined depth threshold, computer system 602 transmits instructions to an external device (e.g., a smart phone that is owned by user 600) that causes the external device to display summary user interface 640.

At FIG. 6K, user 600 descends within the body of water. At FIG. 6K, a determination is made that the depth of computer system 602 transitions from being less than the predetermined depth threshold to being greater than the predetermined depth threshold. Because a determination is made that the depth of computer system 602 transitions from being less than the predetermined depth threshold to being greater than the predetermined depth threshold, computer system 602 begins to track metrics for a second diving session (e.g., that is different from the first diving session) (e.g., as described above in relation to FIG. 6C). Further, because a determination is made that the depth of computer system 602 transitions from being less than the predetermined depth threshold to being greater than the predetermined depth threshold, computer system 602 ceases to display summary user interface 640 and redisplays submersion user interface 610 (e.g., as described above in relation to FIGS. 6B-6E). As illustrated in FIG. 6K, submersion user interface 610 includes time metric 624. At FIG. 6K, time metric 624 indicates the amount of time that computer system 602 has been at a depth that is greater than the predetermined depth threshold during the second diving session. Computer system 602 automatically (e.g., without intervening use input) ceases the display of summary user interface 640 and displays submersion user interface 610 when the depth of computer system 602 transitions from being less than the predetermined depth threshold to greater than the predetermined depth threshold.

At FIG. 6K, a determination is made that that the battery level of computer system 602 is beneath a battery power threshold (e.g., 10%, 15%, 20%, 25%, or 30%). Because a determination is made that the battery level of computer system 602 is beneath the battery power threshold, computer system 602 displays battery power user interface object 652 within submersion user interface 610. Battery power user interface object 652 indicates the current battery power of computer system 602. Submersion user interface 610 does not include temperature metric 620 when submersion user interface 610 includes battery power user interface object 652. In some embodiments, computer system 602 ceases to display battery power user interface object 652 in accordance with a determination that the battery of computer system 602 is above the battery power threshold. In some embodiments, computer system 602 changes the appearance of battery power user interface object 652 (e.g., computer system 602 changes the color and/or size of battery power user interface object 652) (e.g., computer system 602 displays battery power user interface object 652 as flashing) in accordance with a determination that the battery power of computer system 602 is lower than a minimum battery power threshold (e.g., the minimum battery power threshold corresponds to a lower battery power than the battery power that corresponds to the battery power threshold). In some embodiments, when the battery level of computer system 602 is beneath the battery power threshold, submersion user interface 610 includes both temperature metric 620 and battery power user interface object 652.

At FIG. 6L, user 600 ascends within the body of water. At FIG. 6L, a determination is made that the depth of computer system 602 transitions from being greater than the predetermined depth threshold to less than the predetermined depth threshold. At FIG. 6L, because a determination is made that the depth of computer system 602 transitions from being greater than the predetermined depth threshold to less than the predetermined depth threshold, computer system 602 ceases tracking and recording metrics for the second diving session (e.g., as described above in relation to FIG. 6J) and displays summary user interface 640. At FIG. 6L, summary user interface 640 includes a summary of the metrics tracked by computer system 602 during the second diving session (e.g., as described above in relation to FIG. 6J). At FIG. 6L, computer system 602 detects input 650l that corresponds to an activation of side button 638. In some embodiments, summary user interface 640 includes a summary of the metrics that computer system 602 tracked and recorded during the first diving session and the second diving session.

At FIG. 6M, in response to detecting input 650l, computer system 602 ceases the display of summary user interface 640 and redisplays submersion user interface 610. That is, computer system 602 ceases the display of summary user interface 640 in response to detecting activation of a hardware button or in response to detecting that the depth of computer system 602 transitions from being greater than the predetermined depth threshold to less than the predetermined depth threshold. In some embodiments, computer system 600 ceases the display of summary user interface 640 in response to detecting the rotation and/or depression of a rotatable crown hardware button that is integrated into computer system 602.

FIG. 7 is a flow diagram illustrating a method for managing the display of information related to a physical activity using a computer system in accordance with some embodiments. Method 700 is performed at a computer system (e.g., 602) (e.g., a smartwatch, a wearable electronic device, a smartphone, and/or a tablet) (e.g., a computer system that is worn by a user) that is in communication with a display generation component (e.g., a display controller and/or a touch-sensitive display system) and one or more sensors (e.g., accelerometer, gyroscope, water sensor, and/or depth sensor). Some operations in method 700 are, optionally, combined, the orders of some operations are, optionally, changed, and some operations are, optionally, omitted.

As described below, method 700 provides an intuitive way for managing the display of information related to a physical activity. The method reduces the cognitive burden on a user for managing the display of information related to a physical activity, thereby creating a more efficient human-machine interface. For battery-operated computing devices, enabling a user to manage the display of information related to a physical activity faster and more efficiently conserves power and increases the time between battery charges.

While the computer system is submerged (e.g., submerged in water (e.g., a lake, a pond, or an ocean) (e.g., the computer system is submerged via a diver initiating a dive) (e.g., distance from the surface of the water), the computer system displays (702), via the display generation component, a submersion user interface (e.g., 610) (e.g., a user interface that corresponds to a diving application that is installed on the computer system) (e.g., a user interface that corresponds to a diving exercise tracking function).

While displaying the submersion user interface, the computer system detects (704), via the one or more sensors, a first depth at which the computer system is submerged.

In response to detecting (706) the first depth at which the computer system is submerged and in accordance with (708) a determination that the first depth is less than a predetermined depth threshold (e.g., the depth of computer system 602 at FIG. 6B) (e.g., 3 inches, 6 inches, 1 foot, 2 feet, 5 feet or 10 feet), the computer system displays, via the display generation component, a first set of metrics (e.g., 618 and 620) regarding the submersion of the computer system (e.g., depth of the computer system (e.g., centimeters, inches, feet, and/or meters), temperature of the water (e.g., Fahrenheit and/or Celsius), amount of time that the computer system has been submerged, time of day, amount of oxygen left in diver's tank, and/or water pressure) (e.g., the first set of metrics is displayed as a part of displaying the submersion user interface) (e.g., the first set of metrics are updated in real time) and in accordance with (710) a determination that the first depth is greater than the predetermined depth threshold (e.g., the depth of computer system 602 at FIG. 6C), the computer system displays, via the display generation component, a second set of metrics (e.g., 618, 620, and 624), that is different than the first set of metrics, regarding the submersion of the computer system (e.g., the second set of metrics is updated in real time) (e.g., the second set of metrics includes one or more metrics included in the first set of metrics) (e.g., depth of the computer system, temperature of the water, amount of time that the computer system has been submerged, time of day, amount of oxygen left in diver's tank, and/or water pressure). In some embodiments, the submersion user interface is displayed in response to the computer system detecting that the computer system is submerged in water. In some embodiments, the submersion user interface is displayed in response to the computer system detecting an input that corresponds to selection of a user interface element that corresponds to a diving application that is installed on the computer system. In some embodiments, the computer system ceases to display the second set of metrics and displays the first set of metrics in response to detecting that the computer system is no longer submerged at a depth that is greater than the predetermined depth threshold. In some embodiments, the display of the metrics contrasts with the background of the submersion user interface (e.g., the background of the submersion user interface is black and the metrics are white or vice versa). In some embodiments, respective metrics of the first set of metrics and/or the second set of metrics are displayed at different sizes (e.g., a time metric is displayed with a larger size than a water temperature metric). In some embodiments, respective metrics of the first set of metrics and/or the second set of metrics are displayed with different colors (e.g., a time metric is displayed as a first color (e.g., red, yellow, orange, black, and/or white) and a water temperature metric is displayed as a second color that is different than the first color. In some embodiments, the first set of metrics and/or the second set of metrics includes a time metric that indicates how long the computer system has been submerged at a depth that is greater than the predetermined depth threshold. In some embodiments, the first set of metrics and/or the second set of metrics includes a time metric that indicates the total time the computer system has been submerged in water (e.g., at a depth that is less and/or greater than the predetermined depth). In some embodiments, the color of the respective metrics in the first set of metrics and/or the second set of metrics changes colors (e.g., sequentially) (e.g., from white to black or vice versa) as the depth at which the computer system is submerged increases. In some embodiments, the color of the background of the submersion user interface changes (e.g., from black to white or vice versa) as the depth at which the computer system is submerged increases. Displaying a respective set of metrics when a set of prescribed conditions are met (e.g., the computer system is at a depth that is greater than or less than the predetermined depth threshold) allows the computer system to automatically perform a display operation that provides the user with particular set of information based on whether the user is engaged in a diving activity, which performs an operation when a set of conditions has been met without requiring further user input. Displaying a respective set of metrics based on the depth of the computer system provides the user with visual feedback with respect to the present depth of the computer system, which provides improved visual feedback.

In some embodiments, the first set of metrics includes a water depth metric (e.g., 618) (e.g., a representation (e.g., textual and/or graphical representation) of the current depth of the computer system in the water) (e.g., water depth metric is shown in inches, feet, and/or meters) and a water temperature metric (e.g., 620) (e.g., a representation (e.g., textual and/or graphical representation) of the current real-time temperature of the water that the computer system is submerged within) (e.g., the temperature metric is shown in Fahrenheit and/or Celsius).

In some embodiments, the second set of metrics includes a water depth metric (e.g., 618) (e.g., a representation (e.g., textual and/or graphical representation) the current depth of the computer system in the water) (e.g., water depth metric is shown in inches, feet, and/or meters), a water temperature metric (e.g., 620) (e.g., a representation (e.g., textual and/or graphical representation) of the current real-time temperature of the water that the computer system is submerged within) (e.g., the temperature metric is shown in Fahrenheit and/or Celsius), and a dive time metric (e.g., 624) (e.g., a representation (e.g., textual and/or graphical representation) of an amount time that the computer system has been submerged at a depth that is greater than the predetermined depth threshold).

In some embodiments, in response to detecting the first depth at which the computer system (e.g., 602) is submerged and in accordance with a determination that the first depth is greater than the predetermined depth threshold (e.g., as described above in reference to FIG. 6C), the computer system initiates (e.g., automatically (e.g., without an intervening user input) a dive timer (e.g., 624) (e.g., the dive timer tracks the hours, minutes and/or seconds that the computer system is submerged beneath the predetermined depth threshold) (e.g., the dive timer is concurrently displayed with various other metrics (e.g., water depth metric and/or water temperature metric). In some embodiments, while the dive timer is active (e.g., and while the computer system is submerged at a depth that is greater than the predetermined depth threshold), the computer system detects a first change in depth of the computer system from the first depth to a second depth (e.g., as described above in reference to FIG. 6J) (e.g., the second depth is above the first depth). In some embodiments, in response to detecting the first change in depth of the computer system from the first depth to the second depth and in accordance with a determination that the second depth of the computer system is less than the predetermined depth threshold (e.g., as described above in reference to FIG. 6J) (e.g., the second depth is above the predetermined depth threshold), the computer system ceases the operation of the dive timer (e.g., the computer system maintains the operation of the dive timer in accordance with a determination that the second depth of the computer system is greater than the predetermined depth threshold). In some embodiments, the computer system displays the total amount of time that the computer system was submerged at a depth that is greater than the predetermined threshold as a part of ceasing the operation of the dive timer. In some embodiments, the computer system reinitiates the dive timer in response to detecting that that computer system is resubmerged at a depth that is greater than the predetermined depth threshold. Ceasing the operation of the dive timer in response to detecting the first change in depth of the computer system allows the user to control the operation of the dive timer without displaying additional controls, which provides additional control options without cluttering the user interface. Ceasing the operation of the dive timer when prescribed conditions are met (e.g., in accordance with a determination that the second depth of the computer system is less than the predetermined depth threshold), allows the computer system to automatically control the execution of the dive timer such that the dive timer is only active while the user is engaged during a diving activity, which performs an operation when a set of conditions has been meet without requiring further user input.

In some embodiments, in response to detecting the first depth at which the computer system (e.g., 602) is submerged and in accordance with a determination that the first depth is less than a predetermined depth threshold (e.g., the depth of computer system 602 at FIG. 6B), the computer system enters a first operational state (e.g., as described above in reference to FIG. 6B) (e.g., a water lock state) (e.g., a state where the functionalities of the computer system are restricted (e.g., the computer system does not respond to touch inputs while the computer system is in the first operational state)) and in accordance with a determination that the first depth is greater than the predetermined depth threshold (e.g., the depth of computer system 602 at FIG. 6C), the computer system enters a second operational state (e.g., as described above in reference to FIG. 6C) (e.g., a dive lock state) (e.g., a state where the functionalities of the computer system are restricted (e.g., radios (GPS and/or cellular) that are integrated into the computer system are inactive, health sensors (e.g., heart rate sensors and/or blood oxygen sensors) are deactivated) (e.g., the functionality of the computer system is more limited while the computer system is in the dive second operational state than when the computer system is in the first operational state). In some embodiments, the computer system exits the first operational state in response to detecting that the computer system is no longer submerged. In some embodiments, the computer system transitions from the first operational state to the second operational state in response to detecting that the depth of the computer system transitions from being less than the predetermined depth threshold to being greater than the predetermined depth threshold. In some embodiments, the computer system transitions from the second operational state to the first operational state in response to detecting that the depth of the computer system transitions from being greater than the predetermined depth threshold to being less than the predetermined depth threshold. Entering either a first operational state or a second operational state when a set of conditions are met (e.g., the depth of the computer system is less or greater than the predetermined depth threshold), allows the computer system to automatically control the operational state of the computer system such that the computer system is in an appropriate operational state based on the depth of the computer system, which performs an operation when a set of conditions has been met without requiring further user input.

In some embodiments, the computer system detects an event (e.g., receiving a notification from an external computer system, receiving a text message, receiving a notification from an application that is installed on the computer system, generating a notification that corresponds to an application installed on the computer system, receiving an e-mail, and/or the completion of a countdown timer) that corresponds to an alert (e.g., 636) (e.g., a visual alert, a haptic alert, and/or an audio alert) that the computer system (e.g., 602) is configured to output when the event is detected (e.g., the computer system outputs the alert upon detection of the event when the computer system is in a standard (e.g., normal) operating state). In some embodiments, in response to detecting the event and in accordance with a determination that the computer system (e.g., 602) is in the second operational state (e.g., as described above in reference to FIG. 6C), the computer system suppresses the alert (e.g., the computer system does not output the alert) and in accordance with a determination that the computer system is not in the second operational state (e.g., the computer system is in a standard (e.g., normal) operating state), the computer system outputs the alert (e.g., the computer system outputs a visual alert, the computer system outputs an audio alert, and/or the computer system outputs a haptic alert). In some embodiments, the computer system initially suppresses the alert that corresponds to the event while the computer system is in the second operational state and the computer system outputs the alert that corresponds to the event once the computer system exits the second operational state. In some embodiments, the computer system suppresses a first type of alert (e.g., audio, visual, and/or haptic alert) that corresponds to the event and outputs a second type of alert (e.g., audio, visual, and/or haptic alert) that corresponds to the event. In some embodiments, the computer system suppresses the alert when the computer system is in the first operational state. Suppressing an alert that the computer system is configured to output when an event is detected when prescribed conditions are met (e.g., the computer system is in the second operational state) reduces the power consumption of the computer system thereby extending the battery life of the computer system, which improves (e.g., extends) the overall battery life of the computer system.

In some embodiments, the computer system detects a tactile user input (e.g., 650h or 650l) (e.g., a tap input, a press and hold, and/or a swipe) that corresponds to one or more operations of the computer system (e.g., 602) (e.g., the computer system is configured to perform one or more operations in response to detecting the tactile user input when the computer system is in a standard operating (e.g., normal) state). In some embodiments, in response to detecting the tactile user input that corresponds to one or more operations of the computer system and in accordance with a determination that the computer system is in the second operational state (e.g., as described above in reference to FIG. 6C), the computer system suppresses the one or more operations of the computer system (e.g., in accordance with a determination that the computer system is not in the second operational state, performing the one or more operations of the computer system). Suppressing the one or more operations of the computer system in response to detecting a tactile user input when prescribed conditions are met (e.g., the computer system is in the second operational state), reduces the power consumption of the computer system thereby extending the battery life of the computer system, which improves (e.g., extends) the overall battery life of the computer system.

In some embodiments, the computer system (e.g., 602) is in communication with one or more light sources (e.g., the one or more light sources are integrated into the display generation component) (e.g., the display generation component has a backlight). In some embodiments, in accordance with a determination that the computer system is in the second operational state (e.g., as described above in reference to FIG. 6C), the computer system activates the one or more light sources, wherein the light sources illuminate the display generation component (e.g., as described above in reference to FIG. 6C) (e.g., the one or more light sources remain illuminated while the computer system is in the second operational state) (e.g., in accordance with a determination that the computer system is not in the second operational state, the computer system illuminates the one or more light sources based on a set of one or more criteria being satisfied). In some embodiments, the computer system ceases to illuminate the one or more light sources in response to the computer system transitioning from the second operational state to a first operational state and/or a standard (e.g., normal) operating state. In some embodiments, the computer system maintains the illumination of the one or more light sources in response to the computer system transitioning from the second operational state to the first operational state and/or a standard (e.g., normal) operating state. Activating the one or more light sources when a set of prescribed conditions are met (e.g., the computer system is in the second operational state), allows the computer system to automatically control a light operation at a point in time where the amount of ambient lighting is reduced, which performs an operation when a set of conditions has been met without requiring further user input.

In some embodiments, the computer system (e.g., 602) is in communication (e.g., wireless and/or wired communication) with a first hardware button (e.g., a rotatable and depressible crown button) (e.g., the first hardware button is integrated into the computer system). In some embodiments, while the computer system is in the second operational state (e.g., as described above in reference to FIG. 6C) (e.g., and while the computer system is submerged at a depth that is greater than the predetermined depth threshold), the computer system detects an activation of the first hardware button (e.g., a tactile input (e.g., 650l or 650h))(e.g., the first hardware button is depressed) (e.g., the user performs a long press (e.g., a press and hold) input on the first hardware button). In some embodiments, in response to detecting the activation of the first hardware button, the computer system exits the second operational state (e.g., as described above in reference to FIG. 6C) (e.g., and entering the first operational state). In some embodiments, the computer system exits the second operational state while the computer system is submerged at a depth that is greater than the predetermined depth threshold. In some embodiments, the computer system exits the second operational state and enters a standard (e.g., normal) operating state in response to detecting the activation of the first hardware button.

In some embodiments, while the computer system (e.g., 602) is at the first depth (e.g., depth of computer system at FIG. 6G), the computer system detects a second change in depth of the computer system from the first depth to a third depth (e.g., as described above in reference to FIG. 6H) (e.g., the third depth is greater than the first depth). In some embodiments, in response to detecting the second change in depth of the computer system from the first depth to the third depth and in accordance with a determination that third depth is greater than a maximum depths threshold (e.g., the depth of computer system at FIG. 6H) (e.g., as described above in reference to FIG. 6H) (e.g., a maximum depth at which the computer system can track the depth of the computer system) (e.g., 130 feet), the computer system displays a depth warning user interface (e.g., 630) (e.g., the depth warning user interface indicates that depth readings are unavailable while the watch is submerged at a depth that is greater than the maximum depth (e.g., while the depth warning user interface is displayed)) (e.g., the computer system displays the second set of metrics prior to the display of the depth warning user interface and the display of the depth warning user interface replaces the display of the second set of metrics) (e.g., in accordance with a determination that the third depth is not greater than the maximum depth threshold, forgoing display of the depth warning user interface). In some embodiments, the background of the depth warning user interface is displayed as a solid color (e.g., black) and the text of the depth warning user interface is displayed with one or more colors (e.g., yellow, white, orange, and/or red) that contrast with the background of the depth warning user interface. Displaying a depth warning user interface in response to detecting that the computer system is at a depth that is greater than the maximum depth threshold provides the user with visual feedback regarding the current depth of the computer system (e.g., the computer system is at depth that is greater than maximum depth threshold), which provides improved visual feedback. Displaying a depth warning user interface when a set of conditions are met (e.g., the computer system is at a depth that is greater than the maximum depth threshold) allows the computer system to automatically perform a display operation that alerts the user to depth of the computer system, which performs an operation when a set of conditions has been met without requiring further user input.

In some embodiments, while the computer system (e.g., 602) displays the depth warning user interface (e.g., 630), the computer system outputs (e.g., continuously outputs) haptic (e.g., vibrational) alerts (e.g., 636) (e.g., the computer system stops outputting the haptic alerts when the computer system ceases to display the depth warning user interface). In some embodiments, the computer system outputs a visual and/or audio alert while the computer system outputs the haptic alerts. In some embodiments, the computer system ceases outputting the haptic alerts in response to detecting that the depth of the computer system has transitioned from being greater than a maximum depth threshold to less than the maximum depth threshold. In some embodiments, while the depth warning user interface is displayed, the computer system continuously outputs discrete haptic alerts. In some embodiments, while the depth warning user interface is displayed, the computer system outputs a single haptic alert for the duration of the display of the depth warning user interface. Outputting haptic alerts when the depth of the computer system is greater than the maximum depth threshold provides the user with tactile feedback regarding the current depth of the computer system, which provides improved tactile feedback. Outputting haptic alerts when a set of conditions are met (e.g., the computer system is at a depth that is greater than the maximum depth threshold) allows the computer system to automatically output vibrational feedback to a user that alerts the user to the present depth of the computer system, which performs an operation when a set of conditions has been met without requiring further user input.

In some embodiments, while the depth warning user interface (e.g., 630) is displayed, the computer system detects a third change in depth of the computer system (e.g., 602) from the third depth to a fourth depth (e.g., the fourth depth is less than the third depth) (e.g., as described above in reference to FIG. 6J). In some embodiments, in response to detecting the third change in depth of the computer system from the third depth to a fourth depth and in accordance with a determination that the fourth depth is less than the maximum depth threshold (e.g., the depth of computer system 602 at FIG. 6J) (e.g., the third depth is above the maximum depth), the computer system ceases (e.g., automatically (e.g., without intervening user input)) the display of the depth warning user interface (e.g., and ceasing the output of the haptic alerts) (e.g., the computer system maintains the display of the depth warning user interface in accordance with a determination that the fourth depth is greater than the maximum depth threshold). In some embodiments, the computer system displays the second set of metrics as a part of ceasing the display of the depth warning user interface. In some embodiments, the computer system displays the first set of metrics as part of ceasing the display of the depth warning user interface. In some embodiments, the computer system redisplays the depth warning user interface in response to detecting that the depth of the computer system transitions from being less than the maximum depth threshold to being greater than the maximum depth threshold. Ceasing the display of the depth warning user interface in response to detecting that the depth the of the computer system has changed from the third depth to the fourth depth allows the user to cease the display of the depth warning user interface (e.g., by ascending above the maximum depth threshold) without displaying additional controls, which provides additional control options without cluttering the user interface.

In some embodiments, the computer system (e.g., 602) is in communication (e.g., wireless and/or wired communication) with a second hardware button (e.g., 638) (e.g., a rotatable and depressible crown mechanism or a button that is integrated on the side of the computer system). In some embodiments, while the depth warning user interface (e.g., 630) is displayed (e.g., and while the computer system is submerged at a depth that is greater than the maximum depth threshold), the computer system detects an input (e.g., 650h or 650l) (e.g., depressing the second hardware button and/or rotating the second hardware button) that corresponds to an activation of the second hardware button. In some embodiments, in response to detecting the input that corresponds to the activation of the second hardware button, the computer system ceases the display of the depth warning user interface (e.g., and ceasing to output haptics) (e.g., as part of ceasing to display the depth warning, computer system displays a user interface that shows a real time indication of the dive time and the water temperature and an indication that the depth of the computer system is greater than the maximum depth threshold). In some embodiments, the computer system displays the second set of metrics as a part of ceasing the display of the depth warning user interface. In some embodiments, the computer system displays the first set of metrics as part of ceasing the display of the depth warning user interface. Ceasing the display of the depth warning user interface in response to detecting an input that corresponds to the activation of the second hardware button provides the user with visual feedback regarding the state of the computer system (e.g., the computer system has detected the input that corresponds to activation of the second hardware button), which provides improved visual feedback.

In some embodiments, the computer system (e.g., 602) displays two metrics (e.g., 618, 624, 620) (e.g., dive time (e.g., amount of time the computer system has been submerged at a depth that is greater than the predetermined depth threshold) and water temperature (e.g., the real-time water temperature) (e.g., the two metrics are displayed on the submersion user interface) without displaying additional metrics while the computer system is submerged at the fourth depth that is greater than maximum depth threshold (e.g., depth of computer system 602 at FIG. 6F). In some embodiments, in response to detecting that the depth of the computer system has transitioned from being greater than the maximum depth threshold to less than the maximum depth threshold, displays additional metrics in addition to the two metrics. In some embodiments, the computer system tracks three or more metrics while metrics while the two metrics are displayed (e.g., the computer system tracks metrics that are not displayed). Displaying two metrics without displaying additional metrics when the computer system is at a depth that is greater than the maximum depth threshold provides the user with visual feedback regarding the depth of the computer system, which provides improved visual feedback.

In some embodiments, while the second set of metrics (e.g., 618, 624, and 620) is displayed (e.g., and while the depth of the computer system is greater than the predetermined depth threshold), the computer system detects a fourth change in depth of the computer system from the first depth to a fifth depth (e.g., as described in FIG. 6J) (e.g., the fifth depth is less than the first depth) (e.g., the depth of computer system 602 at FIG. 6J). In some embodiments, in response to detecting the fourth change in depth of the computer system from the first depth to the fifth depth and in accordance with a determination that the fifth depth is less than the predetermined depth threshold (e.g., the depth of computer system 602 at FIG. 6J) (e.g., the fifth depth is above the predetermined depth threshold), the computer system ceases (e.g., automatically (e.g., without intervening user input) the display of the second set of metrics and the computer system displays (e.g., automatically (e.g., without intervening user input)) a summary screen user interface (e.g., 640) (e.g., the summary screen user interface includes a subset of the metrics that are included in the second set of metrics). In some embodiments, the summary screen user interface is displayed while the computer system is in a first operational state (e.g., water lock state). In some embodiments, the summary screen user interface is displayed while the computer system is no longer submerged. In some embodiments, the summary screen user interface includes each metric that is included in the second set of metrics. In some embodiments, the summary screen user interface includes a done selectable button that, when selected, causes the summary screen to cease to be displayed. In some embodiments, the computer system ceases the display of the summary screen user interface in response to detecting an activation of one or more hardware controls that are integrated into the computer system. Displaying the summary screen user interface when prescribed conditions are met (e.g., the computer systems transitions from a depth that is greater than the predetermined depth threshold to a depth that is less than the predetermined depth threshold), allows the computer system to automatically perform a display operation that provides the user with information regarding the most recent dive activity of the user, which performs an operation when a set of conditions has been met without requiring further user input. Displaying the summary screen in response to detecting the fourth change in depth of the computer system from the first depth to the fifth that is less than the predetermined depth threshold provides the user with visual feedback regarding the current depth of the computer system, which provides improved visual feedback.

In some embodiments, the summary screen user interface (e.g., 640) includes a maximum depth metric (e.g., 642) (e.g., the maximum depth metric indicates the maximum depth at which the computer system was submerged while the computer system was submerged beneath the predetermined depth threshold), a time under water metric (e.g., 644) (e.g., how long the computer system was submerged beneath the predetermined depth threshold), and a water temperature range metric (e.g., 646) (e.g., a range of water temperatures while the computer system was submerged beneath the predetermined depth threshold).

In some embodiments, while the summary screen user interface (e.g., 640) is displayed, the computer system detects a fifth change in depth of the computer system (e.g., 602) from the fifth depth to a sixth depth (e.g., the sixth depth is greater than the fifth depth) (e.g., as described above in reference to FIG. 6K). In some embodiments, in response to detecting the fifth change in depth of the computer system from the fifth depth to the sixth depth and in accordance with a determination that the sixth depth is greater than the predetermined depth threshold (e.g., the depth of computer system 602 at FIG. 6K), the computer system ceases the display of the summary screen user interface (e.g., and displaying the second set of metrics) (e.g., the computer system maintains the display of the summary screen user interface in accordance with a determination that the sixth depth is less than the predetermined depth threshold. In some embodiments, the computer system displays a second summary screen (e.g., that is different than the initially displayed summary screen) in response to detecting that the depth of the computer transitions from being the fifth depth that is greater than the predetermined depth threshold to a respective depth that is less than the predetermined depth threshold. Ceasing the display of the summary screen user interface in response to detecting the fifth change in depth of the computer system allows the user to control the display of summary screen user interface (e.g., by descending to a depth that is greater than the predetermined depth threshold) without displaying additional controls, which provides additional control options without cluttering the user interface. Ceasing the display of the summary screen user interface when a set of prescribed conditions are met (e.g., the sixth depth is greater than the predetermined depth threshold), allows the computer system to automatically manage the display of the summary screen user interface, which performs an operation when a set of conditions has been met without requiring further user input.

In some embodiments, the computer system (e.g., 602) is in communication (e.g., wired and/or wireless communication) with a third hardware button (e.g., 638) (e.g., a rotatable and/or depressible crown or a hardware button that is integrated into the side of the computer system). In some embodiments, while the summary screen user interface (e.g., 640) is displayed (e.g., and while the computer system is submerged at a depth that is less than the predetermined depth threshold), the computer system detects an activation (e.g., 650l, 650h) of the third hardware button (e.g., a press and hold, a tap input, and/or a rotation of the third ware button). In some embodiments, in response to detecting the activation of the third hardware button, the computer system ceases the display of the summary screen user interface. In some embodiments, the computer system displays the submersion user interface as a part of ceasing the display of the summary screen user interface. In some embodiments, the computer system displays a home screen user interface as a part of ceasing the display of the summary screen user interface. Ceasing the display of the summary screen user interface in response to detecting activation of the third hardware button provides the user with visual feedback regarding the state of the computer system (e.g., the computer system has detected the activation of the third hardware button), which provides the user with improved visual feedback.

In some embodiments, while displaying the submersion user interface (e.g., 610), in accordance with a determination that the battery level of the computer system (e.g., 602) is below a battery level threshold (e.g., the battery level of the computer system is below 5% 10%, 15%, or 20%), the computer system displays a battery level indicator (e.g., 652) (e.g., an icon of a battery that a includes a numerical representation of the current battery level of the computer system). In some embodiments, the battery indicator is concurrently displayed with the first set of metrics or the second set of metrics. In some embodiments, the battery indicator is concurrently displayed with the depth warning user interface. In some embodiments, the battery indicator is displayed while the computer system is submerged at a depth that is greater than the predetermined depth threshold. In some embodiments, the battery indicator is displayed while the computer system is submerged at a depth that is less than the predetermined depth threshold. In some embodiments, the computer system ceases to display the battery level indicator in accordance with a determination that the battery level is above the battery level threshold (e.g., the battery of the computer system is sufficiently charged). Displaying the battery level indicator when a set of conditions are met (e.g., the battery level of the computer system is below a battery level threshold) allows the computer system to automatically perform a display operation that indicates to a user the remaining battery power of the computer system, which performs an operation when a set of conditions has been met without requiring further user input.

In some embodiments, the submersion user interface (e.g., 610) includes a depth animation (e.g., 612) (e.g., a meniscus animation (e.g., an animation that mimics the behavior of the surface of water) (e.g., the depth animation is displayed concurrently with the first set of metrics or the second set of metrics) (e.g., the depth animation is displayed in the background of the submersion user interface). In some embodiments, while the computer system (e.g., 602) is at the first depth (e.g., the depth of computer system 600 at FIG. 6B), the computer system displays the depth animation at a first position on the submersion user interface that corresponds to the first depth (e.g., the position of the display of the depth animation at FIG. 6B). In some embodiments, while the depth animation is displayed at the first position that corresponds to the first depth, the computer system detects a sixth change in depth of the computer system from the first depth to a seventh depth (e.g., as described above in reference to FIG. 6C) (e.g., the seventh depth can be greater than or less than the first depth). In some embodiments, in response to detecting the sixth change in depth of the computer system, the computer system updates the display position of the depth animation from the first position to a second position, different from the first position (e.g., the second position is above or below the first position), on the submersion user interface that corresponds to the seventh depth (e.g., the display of depth animation 612 at FIG. 6C) (e.g., the display position of the depth animation on the display generation component depends on the detected depth of the computer system) (e.g., the location of the display of the depth animation moves down on the display generation component as the depth of the computer system increases and the position of the display of the depth animation moves up on the display generation component as the depth of the computer system decreases). In some embodiments, the depth animation forms a convex shape. In some embodiments, the depth animation forms a concave shape. In some embodiments, the depth animation is displayed a subset of the metrics in the first set of metrics or the second set of metrics. In some embodiments, the depth animation is displayed behind each of the metrics in the first set of metrics or the second set of metrics. Displaying the depth animation at various positions on the submersion user interface based on the depth of the computer system provides the user with visual feedback with respect to the present depth of the computer system, which provides improved visual feedback.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery physical health information to users any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted information regarding the physical health of the user that is of greater interest to the user. Accordingly, use of such personal information data enables users to have calculated control of the delivered information. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of health services, the present technology can be configured to allow users to select to “opt in” or “opt out” of participation in the collection of personal information data during registration for services or anytime thereafter. In another example, users can select not to provide physical activity data for the delivery of targeted physical health recommendations. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, recommendations regarding the user's physical health can be selected and delivered by inferring preferences based on non-personal information data or a bare minimum amount of personal information, such as the content being requested by the device associated with a user, other non-personal information available to healthcare providers, or publicly available information.

What is claimed is:

1. A computer system that is configured to communicate with a display generation component and one or more sensors, the computer system comprising:
one or more processors; and
memory storing one or more programs configured to be executed by the one or more processors, the one or more programs including instructions for:
while the computer system is submerged, displaying, via the display generation component, a submersion user interface;
while displaying the submersion user interface, detecting, via the one or more sensors, a first depth at which the computer system is submerged; and
in response to detecting the first depth at which the computer system is submerged:
in accordance with a determination that the first depth is less than a predetermined depth threshold, displaying, via the display generation component, a first set of metrics regarding the submersion of the computer system; and
in accordance with a determination that the first depth is greater than the predetermined depth threshold, displaying, via the display generation component, a second set of metrics, that is different than the first set of metrics, regarding the submersion of the computer system.

2. The computer system of claim 1, wherein the first set of metrics includes a water depth metric and a water temperature metric.

3. The computer system of claim 1, wherein the second set of metrics includes a water depth metric, a water temperature metric, and a dive time metric.

4. The computer system of claim 1, wherein the one or more programs further include instructions for:
in response to detecting the first depth at which the computer system is submerged and in accordance with a determination that the first depth is greater than the predetermined depth threshold, initiating a dive timer;
while the dive timer is active, detecting a first change in depth of the computer system from the first depth to a second depth; and
in response to detecting the first change in depth of the computer system from the first depth to the second depth and in accordance with a determination that the second depth of the computer system is less than the predetermined depth threshold, ceasing the operation of the dive timer.

5. The computer system of claim 1, wherein the one or more programs further include instructions for:
in response to detecting the first depth at which the computer system is submerged:
in accordance with a determination that the first depth is less than a predetermined depth threshold, entering a first operational state; and
in accordance with a determination that the first depth is greater than the predetermined depth threshold, entering a second operational state.

6. The computer system of claim 5, wherein the one or more programs further include instructions for:
detecting an event that corresponds to an alert that the computer system is configured to output when the event is detected; and
in response to detecting the event:
in accordance with a determination that the computer system is in the second operational state, suppressing the alert; and
in accordance with a determination that the computer system is not in the second operational state, outputting the alert.

7. The computer system of claim 5, wherein the one or more programs further include instructions for:
detecting a tactile user input that corresponds to one or more operations of the computer system; and
in response to detecting the tactile user input that corresponds to one or more operations of the computer system:
in accordance with a determination that the computer system is in the second operational state, suppressing the one or more operations of the computer system.

8. The computer system of claim 5, wherein the computer system is in communication with one or more light sources, and wherein the one or more programs further include instructions for:
in accordance with a determination that the computer system is in the second operational state, activating the one or more light sources, wherein the light sources illuminate the display generation component.

9. The computer system of claim 5, wherein the computer system is in communication with a first hardware button, and wherein the one or more programs further include instructions for:
while the computer system is in the second operational state, detecting an activation of the first hardware button; and
in response to detecting the activation of the first hardware button, exiting the second operational state.

10. The computer system of claim 1, wherein the one or more programs further include instructions for:
while the computer system is at the first depth, detecting a second change in depth of the computer system from the first depth to a third depth;
in response to detecting the second change in depth of the computer system from the first depth to the third depth and in accordance with a determination that third depth is greater than a maximum depth threshold, displaying a depth warning user interface.

11. The computer system of claim 10, wherein, while the computer system displays the depth warning user interface, the computer system outputs haptic alerts.

12. The computer system of claim 10, wherein the one or more programs further include instructions for:
while the depth warning user interface is displayed, detecting a third change in depth of the computer system from the third depth to a fourth depth; and
in response to detecting the third change in depth of the computer system from the third depth to a fourth depth and in accordance with a determination that the fourth depth is less than the maximum depth threshold, ceasing the display of the depth warning user interface.

13. The computer system of claim 10, wherein the computer system is in communication with a second hardware button, and wherein the one or more programs further include instructions for:
while the depth warning user interface is displayed, detecting an input that corresponds to an activation of the second hardware button; and
in response to detecting the input that corresponds to the activation of the second hardware button, ceasing the display of the depth warning user interface.

14. The computer system of claim 10, wherein the computer system displays two metrics without displaying additional metrics while the computer system is submerged at the fourth depth that is greater than maximum depth threshold.

15. The computer system of claim 1, wherein the one or more programs further include instructions for:
while the second set of metrics is displayed, detecting a fourth change in depth of the computer system from the first depth to a fifth depth; and
in response to detecting the fourth change in depth of the computer system from the first depth to the fifth depth and in accordance with a determination that the fifth depth is less than the predetermined depth threshold:
ceasing the display of the second set of metrics; and
displaying a summary screen user interface.

16. The computer system of claim 15, wherein the summary screen user interface includes a maximum depth metric, a time under water metric, and a water temperature range metric.

17. The computer system of claim 15, wherein the one or more programs further include instructions for:
while the summary screen user interface is displayed, detecting a fifth change in depth of the computer system from the fifth depth to a sixth depth; and
in response to detecting the fifth change in depth of the computer system from the fifth depth to the sixth depth and in accordance with a determination that the sixth depth is greater than the predetermined depth threshold, ceasing the display of the summary screen user interface.

18. The computer system of claim 15, wherein the computer system is in communication with a third hardware button, and wherein the one or more programs further include instructions for:
while the summary screen user interface is displayed, detecting an activation of the third hardware button; and
in response to detecting the activation of the third hardware button, ceasing the display of the summary screen user interface.

19. The computer system of claim 1, wherein:
while displaying the submersion user interface, in accordance with a determination that the battery level of the computer system is below a battery level threshold, displaying a battery level indicator.

20. The computer system of claim 1, wherein the submersion user interface includes a depth animation, and wherein the one or more programs further include instructions for:
while the computer system is at the first depth, displaying the depth animation at a first position on the submersion user interface that corresponds to the first depth;
while the depth animation is displayed at the first position that corresponds to the first depth, detecting a sixth change in depth of the computer system from the first depth to a seventh depth; and
in response to detecting the sixth change in depth of the computer system, updating the display position of the depth animation from the first position to a second position, different from the first position, on the submersion user interface that corresponds to the seventh depth.

21. A non-transitory computer-readable storage medium storing one or more programs configured to be executed by one or more processors of a computer system that is in communication with a display generation component and one or more sensors, the one or more programs including instructions for:
while the computer system is submerged, displaying, via the display generation component, a submersion user interface;
while displaying the submersion user interface, detecting, via the one or more sensors, a first depth at which the computer system is submerged; and
in response to detecting the first depth at Which the computer system is submerged:
in accordance with a determination that the first depth is less than a predetermined depth threshold, displaying, via the display generation component, a first set of metrics regarding the submersion of the computer system; and
in accordance with a determination that the first depth is greater than the predetermined depth threshold, displaying, via the display generation component, a second set of metrics, that is different than the first set of metrics, regarding the submersion of the computer system.

22. A method, comprising:
at a computer system that is in communication with a display generation component and one or more sensors:
while the computer system is submerged, displaying, via the display generation component, a submersion user interface;
while displaying the submersion user interface, detecting, via the one or more sensors, a first depth at which the computer system is submerged; and
in response to detecting the first depth at which the computer system is submerged:
in accordance with a determination that the first depth is less than a predetermined depth threshold, displaying, via the display generation component, a first set of metrics regarding the submersion of the computer system; and
in accordance with a determination that the first depth is greater than the predetermined depth threshold, displaying, via the display generation component, a second set of metrics, that is different than the first set of metrics, regarding the submersion of the computer system.
